(19) United States
(12) Patent Application Publication
(10) Pub. No.: US 2022/0174899 A1
(43) Pub. Date: Jun. 9, 2022

(54) Modular Hydroponic Grow Box

(71) Applicant: AQUA DESIGN INNOVATIONS, LLC, San Diego, CA (US)

(72) Inventors: Kevin Zhi LIANG, Dale City, CA (US); Mark HUANG, Spring Valley, CA (US)

(21) Appl. No.: 16/963,256

(22) PCT Filed: Jan. 17, 2019
(86) PCT No.: PCT/US19/14092

§ 371 Date: Jul. 20, 2020

Related U.S. Application Data
(63) Continuation-in-part of application No. 16/131,693, filed on Sep. 14, 2018, now abandoned.
(60) Provisional application No. 62/618,792, filed on Jan. 18, 2018.

(51) Int. Cl. A01G 31/06

(52) U.S. Cl. CPC A01G 31/06

(57) ABSTRACT

A modular hydroponic grow box including a self-contained air filtration system is disclosed herein. The system includes a processor. The processor can receive data from one or several components of the system and can provide control signals to one or several components of the system. The grow box can include a housing. The housing can include: a reservoir portion; and a greenhouse portion. The greenhouse portion can connect to the reservoir portion via a grow tray. A top of the reservoir portion and the greenhouse portion define an enclosed volume. The greenhouse portion can include an inlet aperture and an outlet aperture. The inlet aperture can be obstructed by an inlet filter such that air flowing into the greenhouse portion passes through the inlet filter, and the greenhouse portion can be connected to a fan that can propel air through the inlet aperture and out of the outlet aperture.

### CROSS-REFERENCES TO RELATED APPLICATIONS

The present application is an international application filed under the Patent Cooperation Treaty claiming the benefit of priority (as a continuation-in-part) to U.S. application Ser. No. 16/131,693 filed on Sep. 14, 2018, and U.S. Provisional Application Ser. No. 62/618,792 filed on Jan. 17, 2018, the entire contents of which are expressly incorporated into this disclosure as if set forth fully herein.

### FIELD

The present disclosure relates generally to portable greenhouses, and more specifically to a self-contained modular hydroponic grow box that is collapsible for efficient storage and shipping.

### BACKGROUND

A computer network or data network is a telecommunications network that allows computers to exchange data. In computer networks, networked computing devices exchange data with each other along network links (data connections). The connections between nodes are established using either cable media or wireless media (e.g. WiFi, Bluetooth, etc.). The best-known computer network is the Internet.

### SUMMARY

One aspect of the present disclosure relates to a portable hydroponic grow box (or greenhouse) including a self-contained air filtration system. By way of example only, the system includes a processor that can receive data from one or several components of the system and can provide control signals to one or several components of the system. The system can include a housing that can include a reservoir portion and a greenhouse portion connecting to the reservoir portion via a grow tray. In some embodiments, the greenhouse portion defines an enclosed volume. In some embodiments, the greenhouse portion includes an inlet aperture and an outlet aperture. In some embodiments, the inlet aperture can be obstructed by an inlet filter such that air flowing into the greenhouse portion passes through the inlet filter. In some embodiments, the greenhouse portion includes a fan that can propel air through the inlet aperture and out of the outlet aperture.

In some embodiments, the grow tray includes a sponge having a plurality of troughs arranged in a checkered pattern. In some embodiments, the processor can control the fan to affect the velocity of air passing through the enclosed volume according to at least one of: a humidity level measured in the enclosed volume; a size of a plant in the enclosed volume; a weight of the plant in the enclosed volume; or a temperature level measured in the enclosed volume.

In some embodiments the reservoir portion includes a pump fluidly connected to the grow tray such that pump can deliver water to the grow tray. In some embodiments the reservoir portion includes a humidifying element configured humidify the air in the greenhouse portion. In some embodiments, the humidifying element includes a droplet generator.

In some embodiments, the grow tray includes a plurality of apertures extending through the grow tray and fluidly connecting the reservoir portion to the greenhouse portion such that droplets generated by the droplet generator can enter the greenhouse portion. In some embodiments, the reservoir portion includes a drain and a water level sensor. In some embodiments, the reservoir portion includes a turbidity sensor that can measure the turbidity of water stored in the reservoir portion of the housing.

In some embodiments, the greenhouse portion includes a plurality of sensors. In some embodiments, the plurality of sensors can include at least one of: a light sensor; a humidity sensor; a moisture sensor; an oxygen sensor; a carbon dioxide sensor; or a plant size sensor. In some embodiments, the plurality of sensors include: a light sensor, a humidity sensor positioned to measure the relative humidity of the air in the greenhouse portion; a moisture sensor positioned to measure a moisture level in the grow tray; and a plant size sensor. In some embodiments, the plant size sensor includes a scale. In some embodiments, the plant size sensor includes an optical detection system.

In some embodiments, the greenhouse portion includes an outlet filter obstructing the outlet such that air flowing out of the greenhouse portion passes through the outlet filter. In some embodiments, each of the inlet filter and the outlet filter include a first component and a second component. In some embodiments, the first component includes an activated carbon filter element. In some embodiments, the second element includes a HEPA filter element. In some embodiments, the greenhouse portion includes a UV illuminator positioned to illuminate at least one of the first portion and the second portion of the outlet filter.

In some embodiments, the greenhouse portion includes a plurality of walls extending between a top and a bottom of the greenhouse portion. In some embodiments, the distance between the top and the bottom of the greenhouse portion is at least one of: a constant distance or a variable distance. In some embodiments, the plurality of walls partially define the enclosed volume. In some embodiments, the some or all of the plurality of walls are at least one of: transparent; opaque; or reflective.

In some embodiments, the processor is communicatingly connected to the plurality of sensors. In some embodiments, the greenhouse portion includes a first illumination feature located at the top of the greenhouse portion and a second illumination feature extending at least partially between the top and the bottom of the greenhouse portion. In some embodiments, the second illumination feature includes a plurality of illumination elements located at different positions between the top and the bottom of the greenhouse portion. In some embodiments, the first and second illumination features are controllably connected by the processor. In some embodiments, the processor can selectively power some or all of the illumination elements in the second illumination feature based on a detected size of a plant in the enclosed volume of the greenhouse portion.

Another aspect of the disclosure relates to a portable modular hydroponic grow box having a compact assembly configuration for efficient storage and shipping. In some embodiments the modular hydroponic grow box may include a base unit, one or more greenhouse modules, and a control unit. The modular configuration of the grow box, as well as the various shapes of the components, allow for a customizable growing experience and ease of disassembly for compact storage and shipping.

In some embodiments, the various components of the modular grow box are configured to removably stack on top of one another. In some embodiments, the base unit comprises the bottom of the component stack. In some embodiments, the first greenhouse module is stacked immediately on top of the base unit. In some embodiments, a second greenhouse module is stacked immediately on top of the first greenhouse module. In some embodiments, the control unit is stacked immediately on top of the highest greenhouse module, and comprises the top layer of the component stack.

In some embodiments, the base unit may include one or more of: a housing, a grow tray, a water reservoir, a fill pump, a circulating pump, and a water level monitoring system. In some embodiments the base unit has a pyramidal frustum shape (having a trapezoidal cross-section) wherein the top of the housing comprises the minor base of the pyramidal frustum and the bottom comprises the major base of the pyramidal frustum. As used herein, “pyramidal frustum” is defined as a pyramid in which the apex has been removed by a cut parallel to the plane of the base of the pyramid, resulting in truncated pyramid having a major base (formerly the base), a minor base that is parallel to the major base (resulting from the planar cut that removed the apex), and a trapezoidal cross-sectional shape.

In some embodiments, the grow tray may comprise one or several portions for receiving and/or containing seeds and/or root media. In some embodiments, the root media can comprise a granular material such as sand, gravel, pebbles, clay balls, beads, glass beads, or the like. A plant rooted within the grow tray will grow out of the grow tray into the first and second greenhouse modules. In some embodiments, the grow tray can comprise a water inlet and a water outlet. In some embodiments, the water inlet can be connected to a water delivery device (e.g. fill pump by way of flexible tube) and the water outlet can be fluidly connected to the water reservoir such that any excess water can return to the reservoir. In some embodiments, the grow tray can be associated with one or several sensors. In some embodiments, these sensors can include, for example, a moisture sensor configured to determine a moisture level in the grow tray, a scale configured to determine the weight of the plant growing from the grow tray, or the like.

In some embodiments, the top and bottom of the first greenhouse module are open, enabling unobstructed air flow and plant growth from the base unit through the first greenhouse module and into the second greenhouse module. In some embodiments, the first greenhouse module has an inverted pyramidal frustum shape (having a trapezoidal cross-section), wherein the top comprises the major base of the pyramidal frustum and the bottom comprises the minor base of the pyramidal frustum. This inverted pyramidal frustum shape is advantageous in that it allows the interior volume to increase as the first greenhouse module increases in height, giving plants growing within the hydroponic grow box more volume to grow into. Furthermore, the inverted pyramidal frustum shape is critical in enabling the collapsed configuration of the hydroponic grow box.

In some embodiments, the first greenhouse module includes an access opening providing a user access to the plant (e.g. to harvest leaves, flowers, seeds, etc.) and the base unit (e.g. to add water and/or fertilizer to the reservoir, and remove water from the reservoir, etc.). In some embodiments, a cover that is sized and configured to fully obstruct and seal the access opening may be magnetically associated with the access opening. In some embodiments, first greenhouse module may include an inlet aperture and a filter assembly obstructing the inlet aperture.

In some embodiments, the second greenhouse module includes an access opening providing a user access to the plant (e.g. to harvest leaves, flowers, seeds, etc.). In some embodiments, a cover that is sized and configured to fully obstruct and seal the access opening may be magnetically associated with the access opening.

In some embodiments, the control unit includes a control panel. In some embodiments, the control panel comprises a processor, communications module, user input feature, and a display. In some embodiments, the processor can be configured to receive data from one or more of the components of the grow box and to provide control signals to one or more components of the grow box. In some embodiments, the processor can be configured to control the operation of the hydroponic grow box according to computer code which can be, for example, stored in computer readable media (e.g. memory, etc.) accessible by the processor. In some embodiments, the communications module can be configured to send and/or receive data to and/or from a user device (e.g. computer, smart phone, smart watch, personal digital assistant, tablet computer, etc.). In some embodiments, the user can, via communication with the control panel by way of the communications module and/or user input feature and/or touch-screen enabled display, affect the operation of the grow box. The communications module can be configured to communicate via a wired and/or wireless connection with the user device via one or several communications protocols or standards (e.g. Ethernet, Wifi, Bluetooth, etc.).

In some embodiments, the user can input instructions to the processor by way of the user input feature of the control panel (and/or connected user device) in response to the received data to affect a change in operation of the grow box to achieve a desired outcome. In some embodiments, a user can proactively affect a change in the operation of the grow box to achieve a desired outcome by communicating with the processor via the user input feature.

In some embodiments, the processor can be programmed with instructions to automatically respond to certain data thresholds (e.g. too warm, too humid, etc.) to affect a change in the operation of the grow box to achieve a desired outcome. In some embodiments, the processor can be programmed with instructions to control operations according to a specific schedule.

The processor may be implemented as one or more integrated circuits (e.g., a conventional microprocessor or microcontroller). One or more processors, including single core and/or multicore processors, may be included in processing unit. The processing unit may be implemented as one or more independent processing units and/or with single or multicore processors and processor caches included in each processing unit. In other embodiments, processing unit may also be implemented as a quad-core processing unit or larger multicore designs (e.g., hexa-core processors, octo-core processors, ten-core processors, or greater).

In some embodiments, control unit includes one or several exhaust fans, a power coupling configured to receive one end of a A/C or D/C power cord (e.g. for plugging into a wall outlet), and one end of the power cable that connects the base unit to the power module. In some embodiments the control unit may include a lighting component, one or more circulation fan, and a plurality of air vents to allow airflow from the interior volume of the greenhouse module(s) to the inner cavity of the control unit. In some embodiments, the circulating fans are oriented at an angle such that the airflow from the circulating fans may be directed across the prevailing airflow driven by the exhaust fans, creating better airflow within the grow box. The circulating fans may be controlled by the processor, and may be on an automatic schedule or may be activated manually by a user. In some embodiments, the air vents are located on the bottom of the control unit proximate the front side. This ensures that the airflow driven by the exhaust fans occurs diagonally from back to front.

In some embodiments the inner cavity of the control unit may include an LED heatsink, power module, and filter unit. The LED heatsink is provided to help cool the LED lighting component. The power module can be configured to power the growbox and can include, for example, one or several plugs, energy storage devices such as batteries, connectors, or the like. The filter unit includes an activated carbon exhaust filter which again filters the air as it is exiting the grow box, further cleaning the air circulated within the room that the hydroponic grow box of the present example is located in.

In some embodiments, the module hydroponic grow box creates a unique dual filtered airflow experience. In operation, the one or several fans create a vacuum which causes air to be drawn into the first greenhouse module through the inlet aperture and filter (e.g. particle intake filter). The air is pulled through the first and second greenhouse modules and through the air vents in the control unit and finally through the activated carbon exhaust filter on its way out through the exhaust fans and outlet aperture.

In some embodiments, the one or more circulating fans create additional airflow to encourage growth and flowering of the plant. Since the circulating fans have an angled orientation, that the airflow (e.g. diagonally downward back-to-front) from the circulating fans may be directed across the prevailing airflow (e.g. diagonally upward back-to-front) driven by the exhaust fans, creating better airflow within the grow box.

In some embodiments, the compact configuration of the hydroponic grow box is enabled by the pyramidal frustum shape of the first greenhouse module in combination with the pyramidal frustum shape of the base unit. Starting with the base unit placed on a stable flat surface (e.g. floor, table, desk, etc.), the first step is to invert the first greenhouse module and place over the base unit such that the top of the housing (e.g. minor base of the base unit pyramidal frustum) passes through the top aperture and into the interior volume of the first greenhouse module. The base unit is sized and shaped such that a substantial portion of the base unit is received within the interior volume of the first greenhouse module. The tapered sides of the base unit allow greater penetration than would be feasible if the base unit had vertical sides. Once the inverted first greenhouse module has been seated on top of the base unit, the second greenhouse module may be placed over the inverted first greenhouse module such that the bottom of the first greenhouse module (e.g. minor base of the pyramidal frustum) passes through the bottom aperture and into the interior volume of the second greenhouse module. Once the second greenhouse module has been fully seated over the first greenhouse module, the control unit may be placed on top of the second greenhouse module as normal. This compact assembly feature reduces the height of the grow box and also significantly lowers the center of gravity, making the modular hydroponic grow box described herein easier to store and transport.

As additional description to the embodiments, described below, the present disclosure describes the following embodiments.

Embodiment 1 is a stackable hydroponic greenhouse system, comprising: (1) a base unit including a water reservoir sized and configured to receive a volume of water therein, and a grow tray sized and configured to receive a volume of plant root media therein, the base unit comprising a housing element having a pyramidal frustum shape; (2) a first greenhouse module having four lateral walls, an open top end, an open bottom end, and a first interior volume defined by the space between the four lateral walls and top and bottom ends, the first greenhouse module having an inverted pyramidal frustum shape, the first greenhouse module configured to stack on top of the base unit; (3) a second greenhouse module having four lateral walls, a top end, an open bottom end, and a second interior volume defined by the space between the four lateral walls and top and bottom ends, the second greenhouse module configured to stack on top of the first greenhouse module; and (4) a control unit configured to stack on top of the second greenhouse module, the control unit including a control panel, a power module, a processor, and a lighting component.

Embodiment 2 is the system of embodiment 1, wherein the base unit further comprises a fill pump configured to pump water from the water reservoir to at least one of the grow tray and a discard bucket.

Embodiment 3 is the system of embodiments 1 or 2, wherein the base unit further comprises a circulation pump configured to intake water from the water reservoir and pump the water back into the water reservoir.

Embodiment 4 is the system of any one of embodiments 1 through 3, wherein the grow tray comprises a container having an upper facing opening, a bottom panel, and at least one side wall extending between the top and bottom panels, the bottom panel including at least one egress aperture fluidly associated with the water reservoir.

Embodiment 5 is the system of any one of embodiments 1 through 4, wherein the base unit further comprises a water level monitor.

Embodiment 6 is the system of embodiment 5, wherein the water level monitor comprises at least one sensor element and at least one indicator element.

Embodiment 7 is the system of embodiment 6, wherein the at least one sensor is a float sensor.

Embodiment 8 is the system of any one of embodiments 1 through 7, wherein the first greenhouse module comprises an access aperture configured to allow access to at least one of the first interior volume and the base unit, and a removable cover configured to sealingly cover the access aperture.

Embodiment 9 is the system of embodiment 8, wherein the cover is magnetically associated with the access aperture.

Embodiment 10 is the system of any one of embodiments 1 through 9, wherein the first greenhouse module further includes an air intake aperture obstructed by a filter element.

Embodiment 11 is the system of any one of embodiments 1 through 10, wherein the second greenhouse module comprises an access aperture configured to allow access to at least one of the second interior volume and the first interior volume, and a removable cover configured to sealingly cover the access aperture.

Embodiment 12 is a stackable hydroponic greenhouse system, comprising: (1) a base unit including a water reservoir sized and configured to receive a volume of water therein, and a grow tray sized and configured to receive a volume of plant root media therein; (2) a first greenhouse module having four lateral walls, an open top end, an open bottom end, and a first interior volume defined by the space between the four lateral walls and top and bottom ends, the first greenhouse module further comprising an air intake aperture and first filter element obstructing the air intake element, the first greenhouse module configured to stack on top of the base unit; (3) a second greenhouse module having four lateral walls, a top end, an open bottom end, and a second interior volume defined by the space between the four lateral walls and top and bottom ends; and (4) a control unit configured to stack on top of the second greenhouse module, the control unit including a control panel, a power module, a lighting component, an air outlet aperture, an exhaust fan positioned proximate the air outlet aperture, and a second filter element obstructing the air outlet aperture; wherein the exhaust fan is operable to create a vacuum environment within the first and second interior volumes to create a first airflow pattern wherein air is pulled into the first interior volume through the air intake aperture and first filter element and passes diagonally upward through the second interior volume and control unit before exiting the greenhouse system through the second filter element, exhaust fan, and outlet aperture.

Embodiment 13 is the system of embodiment 12, wherein at least one of the base unit and the first greenhouse module has a pyramidal frustum shape.

Embodiment 14 is the system of embodiment 12 or 13, wherein the first filter element comprises a particle intake filter.

Embodiment 15 is the system of any one of embodiments 12 through 14, wherein the second filter element comprises an activated carbon exhaust filter.

Embodiment 16 is the system of any one of embodiments 12 through 15, wherein the control unit further includes at least one circulating fan positioned on a bottom side of the control unit, the at least one circulating fan angularly directed into the second interior volume to create a second airflow pattern passing diagonally downward through the second interior volume and into the first interior volume.

Embodiment 17 is a method of assembling a stackable hydroponic greenhouse system in a compact orientation for efficient storage or shipping, comprising the steps of: a) providing a stackable hydroponic greenhouse system including: (i) a base unit including a water reservoir sized and configured to receive a volume of water therein, and a grow tray sized and configured to receive a volume of plant root media therein, the base unit comprising a housing element having a pyramidal frustum shape; (ii) a first greenhouse module having four lateral walls, an open top end, an open bottom end, and a first interior volume defined by the space between the four lateral walls and top and bottom ends, the first greenhouse module having an inverted pyramidal frustum shape, the first greenhouse module configured to stack on top of the base unit; (iii) a second greenhouse module having four lateral walls, a top end, an open bottom end, and a second interior volume defined by the space between the four lateral walls and top and bottom ends, the second greenhouse module configured to stack on top of the first greenhouse module; and (iv) a control unit configured to stack on top of the second greenhouse module, the control unit including a control panel, a power module, and a lighting component; b) inverting the first greenhouse module; c) placing the inverted first greenhouse module over the control unit such that a substantial portion of the control unit is received within the first interior volume; d) placing the second greenhouse module over the inverted first greenhouse module such that at least a portion of the first greenhouse module is received within the second interior volume, and e) placing the control unit on top of the second greenhouse module to complete the assembly of the stackable hydroponic greenhouse system into a compact orientation.

Embodiment 18 is the method of embodiment 17, comprising the further step of f) packing the compact assembly into at least one of a storage container and a shipping container.

Embodiment 19 is the method of embodiment 17 or 18, comprising the further step of g) shipping the compact assembly.

### BRIEF DESCRIPTION OF THE DRAWINGS

Many advantages of the present disclosure will be apparent to those skilled in the art with a reading of this specification in conjunction with the attached drawings, wherein like reference numerals are applied to like elements and wherein:

FIG. 1 is a perspective view of an example of a portable hydroponic grow box including a self-contained air filtration system according to one embodiment of the disclosure;

FIG. 2 is a perspective view of an example of a grow tray forming part of the hydroponic grow box of FIG. 1;

FIG. 3 is an exploded perspective view of the hydroponic grow box of FIG. 1;

FIG. 4 is a schematic view of an example of a first illumination feature forming part of the hydroponic grow box of FIG. 1;

FIG. 5 is a perspective view of an example of a second illumination feature forming part of the hydroponic grow box of FIG. 1;

FIG. 6 is an exploded perspective view of an example of a filtration member forming part of the hydroponic grow box of FIG. 1;

FIG. 7 is a perspective view of an example of a reservoir portion forming part of the hydroponic grow box of FIG. 1;

FIG. 8 is a top view the reservoir portion of FIG. 7;

FIG. 9 is a side view of an example of a drain spout forming part of the hydroponic grow box of FIG. 1;

FIG. 10 is a front plan view of an example of a hydroponic grow box according to another embodiment of the disclosure;

FIG. 11 is a front plan view of another example of a hydroponic grow box according to another embodiment of the disclosure;

FIG. 12 is an exploded front plan view of the hydroponic grow box of FIG. 10;

FIG. 13 is a front plan view of the hydroponic grow box of FIG. 10 in a collapsed configuration;

FIG. 14 is a rear plan view of the hydroponic grow box of FIG. 10;

FIG. 15 is a perspective view of an example of a base unit forming part of the hydroponic grow box of FIG. 10;

FIG. 16 is a perspective view of an example of a grow tray forming part of the hydroponic grow box of FIG. 10;

FIG. 17 is a side plan view of the base unit of FIG. 15 with the front wall removed, illustrating in particular an example of a water level monitoring system forming part of the hydroponic grow box of FIG. 10;

FIG. 18 is a side plan view of the base unit of FIG. 15 with the front wall removed;

FIG. 19 is a perspective view of an example of a first greenhouse module forming part of the hydroponic grow box of FIG. 10;

FIG. 20 is an exploded perspective view of the first greenhouse module of FIG. 19;

FIG. 21 is a top perspective view of an example of a second greenhouse module forming part of the hydroponic grow box of FIG. 10;

FIG. 22 is a bottom perspective view of the second greenhouse module of FIG. 21 with a door panel removed;

FIG. 23 is a bottom perspective view of an example of a control unit forming part of the hydroponic grow box of FIG. 10;

FIG. 24 is a bottom plan view of the control unit of FIG. 23;

FIG. 25 is a rear perspective view of the control unit of FIG. 23;

FIG. 26 is a top perspective view of the control unit of FIG. 23 with the top panel removed;

FIG. 27 is a side transparent view of the hydroponic grow box of FIG. 10, illustrating in particular the pattern of air flow through the grow box; and

FIG. 28 is a side transparent view of the hydroponic grow box of FIG. 10, illustrating in particular the pattern of air circulation within the first and second greenhouse modules.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF A PREFERRED EMBODIMENT

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. The modular hydroponic grow box and related methods disclosed herein boasts a variety of inventive features and components that warrant patent protection, both individually and in combination.

The ensuing description provides illustrative embodiment(s) only and is not intended to limit the scope, applicability or configuration of the disclosure. Rather, the ensuing description of the illustrative embodiment(s) will provide those skilled in the art with an enabling description for implementing a preferred exemplary embodiment. It is understood that various changes can be made in the function and arrangement of elements without departing from the spirit and scope as set forth in the appended claims.

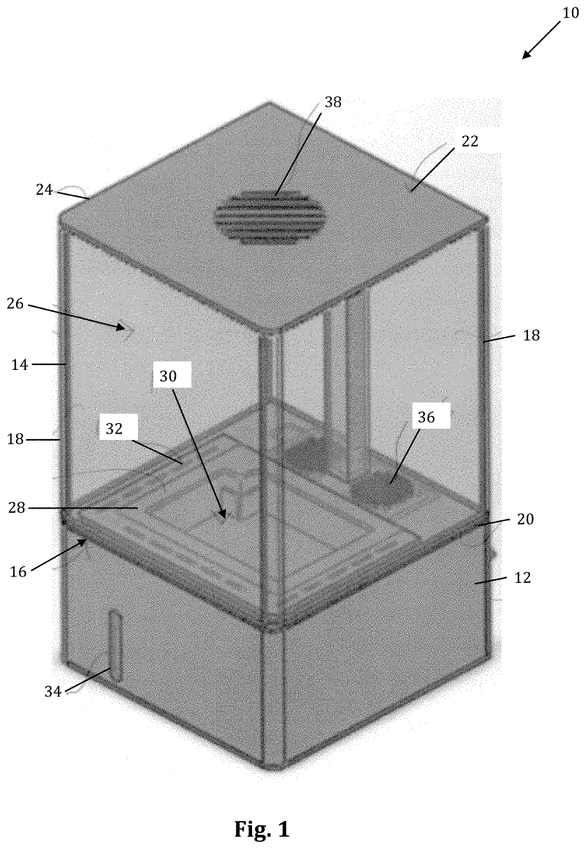

With reference now to FIG. 1, a perspective view of an example of a portable hydroponic grow box 10 according to an embodiment of the disclosure is shown. In some embodiments, the hydroponic grow box 10 can include a reservoir portion 12 and a greenhouse portion 14 that can removably sit on a top 16 of the reservoir portion 12.

The greenhouse portion 14 can comprise a plurality of walls 18 that can extend from a bottom 20 of the greenhouse portion 14 to a top 22 of the greenhouse portion 14. In some embodiments, these walls 18 can comprise a fixed size, and in some embodiments, these walls can comprise a variable size. Specifically, in some embodiments, the distance between the top 22 and the bottom 20 of the greenhouse portion 14 can vary based on a detected size of the plant growing in the enclosed volume 26. In some embodiments, one or several of the plurality of walls can be translucent, opaque, and/or reflective.

In some embodiments, the top 22 of the greenhouse portion 14 can comprise roof 24, and in some embodiments, the bottom 20 of the greenhouse portion 14 can be open. The plurality of walls 18, the top 22, and the bottom 20 of the greenhouse portion 14 can together define an enclosed volume 26 that can be sized and shaped to receive and grow a plant. In some embodiments, the greenhouse portion 14 can comprise a plurality of sensors configured to detect one or several attributes of the greenhouse portion 14, the enclosed volume 26, and/or of the plant growing in the enclosed volume 26. In some embodiments, these sensors can include at least one of: a light sensor; a humidity sensor; a moisture sensor; an oxygen sensor; a carbon dioxide sensor; and/or a plant size sensor. In some embodiments, these sensors can include: a light sensor, a humidity sensor positioned to measure the relative humidity of the air in the greenhouse portion; a moisture sensor positioned to measure a moisture level in the grow tray; and/or a plant size sensor. In some embodiments, the plant size sensor can comprise a scale, and in some embodiments, the plant size sensor can comprise an optical sensor.

The hydroponic grow box 10 can further include a grow tray 28 that can be received within the reservoir portion 12. The grow tray 28 can comprise a variety of shapes and sizes and can be made from a variety of materials. In some embodiments, the grow tray 28 can comprise a polymer, a foam, or the like. In some embodiments, the grow tray 28 can comprise a water permeable material. In some embodiments, the grow tray 28 can comprise a water inlet and a water outlet. In some embodiments, the water inlet can be connected to a water delivery device and the water outlet can be connected to the reservoir of the reservoir portion 12 such that any excess water can return to the reservoir.

In some embodiments, the grow tray 28 can be associated with one or several sensors. In some embodiments, these sensors can include, for example, a moisture sensor configured to determine a moisture level in the grow tray 28, a scale configured to determine the weight of the plant growing from the grow tray 28, or the like.

In some embodiments, the grow tray 28, when received within the reservoir portion 12 can be sloped and/or angled such that a liquid provided to a top of the sloped portion will run towards and to the bottom of the sloped portion. Specifically, in some embodiments, the grow tray 28 can be sloped from the water inlet to the water outlet such that water delivered to the grow tray 28 at the water inlet will travel to or towards the water outlet where the water will drain from the grow tray 28. In some embodiments, this slope can be between approximately 1 and 45 degrees. As used anywhere herein, “approximately” refers to a range of +/−10% of the value and/or range of values for which “approximately” is used.

In some embodiments, the grow tray 28 can comprise one or several portions for receiving and/or containing seeds and/or root media. In some embodiments, these one or several portions can comprise one or several troughs 30. In some embodiments, the root media can comprise a granular material such as sand, gravel, pebbles, clay balls, beads, glass beads, or the like.

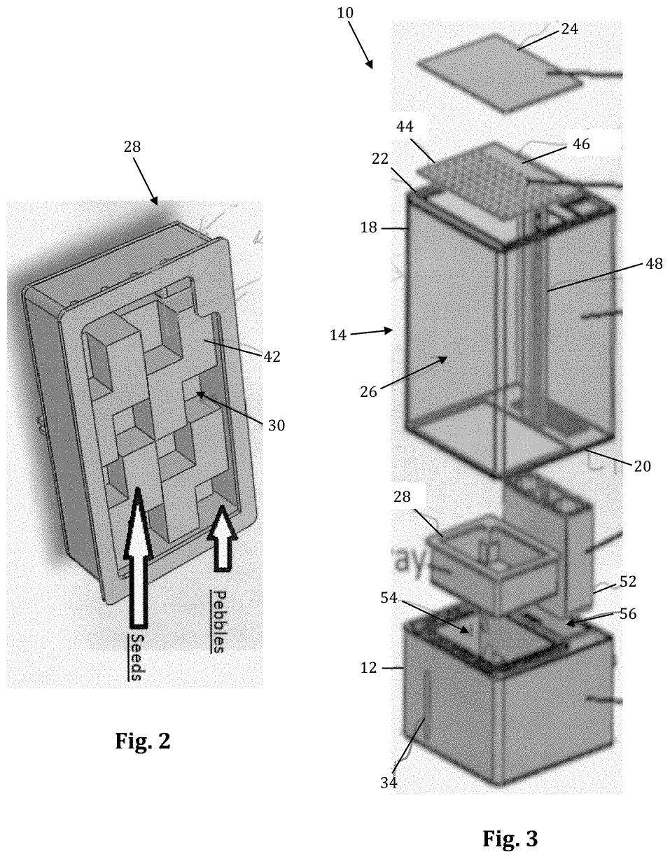

One embodiment of the grow tray 28 is depicted in FIG. 2. In this embodiment, the grow tray 28 comprises a sponge having a plurality of troughs 30 arranged in a checkered pattern. In the embodiment depicted in FIG. 2, a plurality of ridges and/or pedestals 42 are interspersed between the troughs 30.

In embodiments in which the greenhouse portion 14 is on top of the reservoir portion 12, the top 16 of the reservoir portion 12 and the grow tray 28 can be proximate to the bottom 20 of the greenhouse portion 14. In some embodiments, the top 16 of the reservoir portion 12 and the grow tray 28 can sealingly mate with the portions of the plurality of walls 18 proximate to the bottom 20 of the greenhouse portion 14 to thereby seal the enclosed volume.

In some embodiments, the reservoir portion 12 can include a plurality of apertures 32 located in portions of the top 16 of the reservoir portion 12. In some embodiments, these apertures can fluidly or pneumatically connect a reservoir of the reservoir portion 12 with the enclosed volume 26 of the greenhouse portion with the top 16 of the reservoir portion 12 and the grow tray 28 seal the enclosed volume 26. In some embodiments, the apertures 32 can allow fog or mist to rise from the reservoir of the reservoir portion 12 into the enclosed volume 26.

The reservoir portion 12 can further include a water level indicator 34 that can be, for example, associated with a water level sensor. In some embodiments, the water level indicator 34 can provide an indicator of the level of the water inside of the reservoir of the reservoir portion 12. In some embodiments, the indicator can comprise a visual indicator such as, for example, one or several Light Emitting Diodes (LED) that can change illumination and/or color based on the water level in the reservoir.

In some embodiments, the reservoir portion 12 can further include one or several sensors configured to detect and/or monitor an attribute of the water in the reservoir portion 12. In some embodiments, this can include, for example, a turbidity sensor configured to measure the turbidity of the water in the reservoir portion 12.

The hydroponic grow box 10 can further include an inlet aperture 36 and an outlet aperture 38. In some embodiments, the inlet aperture 36 can be configured to allow air to enter into the enclosed volume 26 and in some embodiments, the outlet aperture 38 can be configured to allow air to exit the enclosed volume 26. The inlet aperture 36 and the outlet aperture 38 can comprise a variety of shapes and sizes and can be placed in a variety of locations. In the embodiment depicted in FIG. 1, the inlet aperture 36 is located in the top 16 of the reservoir portion 12 and the outlet aperture 38 is located in the roof 24 at the top 22 of the greenhouse portion 14.

One or both of the inlet aperture 36 and the outlet aperture 38 can be associated with one or several air treatment elements, components, or systems. In some embodiments this can include, for example, one or several fans, filters, filter elements, illumination devices, or the like. In some embodiments, the one or several air treatment elements, components, or systems associated with one or both of the inlet aperture 36 and the outlet aperture 38 can include one or several UV illuminators. In some embodiments, for example, the treatment elements, components, or systems associated with the outlet aperture 38 can comprise a UV illuminator configured to sterilize the treatment elements, components, or systems.

The hydroponic grow box 10 can further include a vertical strut 40. In some embodiments, the vertical strut 40 can comprise an elongate member extending from the bottom 20 of the greenhouse portion 14 to the top 22 of the greenhouse portion 14. The vertical strut 40 can comprise a variety of shapes and sizes. In some embodiments, the vertical strut 40 can comprise a member having a wholly or partially defined internal volume that can contain one or several wires configured for powering components such as one or several lights, fans, LEDs, sensors, or the like in the greenhouse portion 14. In some embodiments, the vertical strut 40 can be further configured to connect with lighting components 44 to provide support for one or several lighting components 44. In some embodiments, for example, one or both of the first illumination feature 46 and the second illumination feature 48 can connect to and/or be mounted on the vertical strut 40.

In some embodiments, the vertical strut 40 can be configured to electrically connect with the reservoir portion 12 to thereby provide power from the reservoir portion 12 and the therein contained power module 94 to the greenhouse portion 14. In some embodiments, for example, this connection can be achieved via one or several electrical connectors, and specifically by four electrical connectors that can be located in the vertical strut 40 and that can mate with four mating connectors located in the reservoir portion 12. In some embodiments, these one or several electrical connectors can be spring-loaded.

With reference now to FIG. 3, an exploded view of one embodiment of the hydroponic grow box 10 is shown. FIG. 3 depicts the reservoir portion 12, the greenhouse portion 14, and the grow tray 18. As seen in FIG. 3, the greenhouse portion 14 includes the plurality of walls 18, the roof 24, also referred to herein as the cover 24, and lighting components 44. In some embodiments, the lighting components 44 can comprise a variety of shapes and sizes and be placed in a variety of locations in and/or around the greenhouse portion 14. In some embodiments, the lighting components 44 can be controlled to selectively illuminate all or portions of the enclosed volume 26 and/or the plant growing within the enclosed volume 26.

In some embodiments, the lighting components 44 can comprise a first illumination feature 46 located at the top 22 of the greenhouse portion 14 and a second illumination feature 48 extending at least partially between the top 22 and the bottom 20 of the greenhouse portion 14. In some embodiments, each of the first and second illumination features 46, 48 can comprise a plurality of illumination elements 50, which illumination elements 50 can generate electromagnetic radiation in response to receipt of a current. In some embodiments, these illumination elements 50 can comprise one or several lights, light bulbs, LEDs, or the like.

The illumination elements 50 can comprise a single type of illumination element, and in some embodiments, the illumination elements 50 can comprise a plurality of types of illumination elements 50. In some embodiments, some or all of the types of illumination elements 50 can generate different wavelengths of electromagnetic radiation, generate different powers of electromagnetic radiation, or the like.

In some embodiments, the illumination elements 50 can be located at different positions on one or both of the first and second illumination features 46, 48. In one embodiment, for example, the illumination elements 50 of the second illumination feature 48 can be located at different positions between the top 22 and the bottom 20 of the greenhouse portion 14. In some embodiments, a processor in the system 10 can control some or all of the illumination elements 50 and/or the first and second illumination features 46, 48 to achieve a desired illumination. In some embodiments this can include providing illumination with one or several desired wavelengths, ratio of wavelengths, or the like. In some embodiments, providing a desired illumination can include selectively powering illumination elements 50 based on a detected size of the plant in the enclosed volume 26. In some embodiments, this can include the processor determining the size of the plant in the enclosed volume 26, the processor selecting the illumination elements 50 of, for example, the second illumination feature 48 corresponding to the detected size of the plant in the enclosed volume 26, and the processor powering the selected illumination elements 50. Thus, in some embodiments, as the plant grows, the illumination elements 50 in the second illumination feature 48 can be controlled by the processor such that a taller plant is illuminated by more illumination elements 50 in the second illumination feature 48 and that the illumination elements 50 used to illuminate the plant in the enclosed volume are selected as having a position between the top 22 and the bottom 20 of the greenhouse portion 14 corresponding to the detected size of the plant growing in the enclosed volume 26.

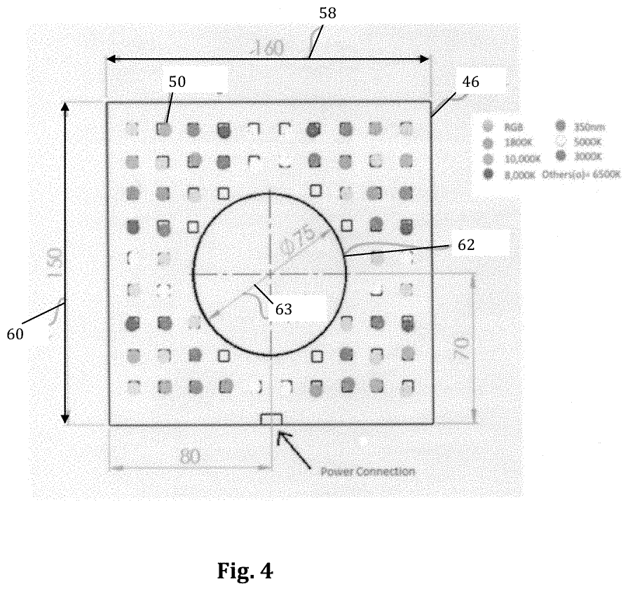

With reference now to FIG. 4, a schematic view of one embodiment of a layout of the first illumination feature 46, also referred to herein as the LED PCB 46, is shown. The LED PCB 46 can comprise a variety of shapes and sizes and can be made from a variety of materials. In some embodiments, the LED PCB 46 can comprise a rectangle defined by a length 58 and a width 60. In some embodiments, the length 58 can be between approximately 100 and 200 millimeters and/or between approximately 125 and 175 millimeters, the length 58 can be approximately 160 millimeters, and/or any other or intermediate value or range. In some embodiments, the width 60 can be between approximately 100 and 200 millimeters and/or between approximately 125 and 175 millimeters, the width can be approximately 150 millimeters, and/or any other or intermediate value or range.

In some embodiments, the LED PCB 46 can define an aperture 62 that can be, for example, a circular aperture. In some embodiments, the aperture 62 can be centrally located on the LED PCB 46 as is shown in FIG. 4. The aperture 62 shown in FIG. 4 can comprise a diameter 63 of between 50 and 100 millimeters and/or a diameter of approximately 75 millimeters.

The LED PCB 46 can comprise a plurality of illumination elements 50. In some embodiments, this can include any desired of illumination elements 50 including, for example, approximately 10 illumination elements 50, approximately 20 illumination elements 50, approximately 50 illumination elements 50, approximately 66 illumination elements 50, approximately 75 illumination elements 50, approximately 100 illumination elements 50, and/or any other or intermediate number of illumination elements 50. In some embodiments, these illumination elements 50 can comprise RGB LEDs, 350 nm LEDs, 1800K LEDs, 3,000K LEDs, 5,000K LEDs, 6,500K LEDs, 8,000K LEDs, and/or 10,000K LEDs. In the specific embodiment depicted in FIG. 4, the LED PCB 302 comprises sixteen RGB LEDs, six 350 nm LEDs, six 1800K LEDs, eight 3,000K LEDs, ten 5,000K LEDs, six 6,500K LEDs, 8,000K LEDs, and/or eight 10,000K LEDs.

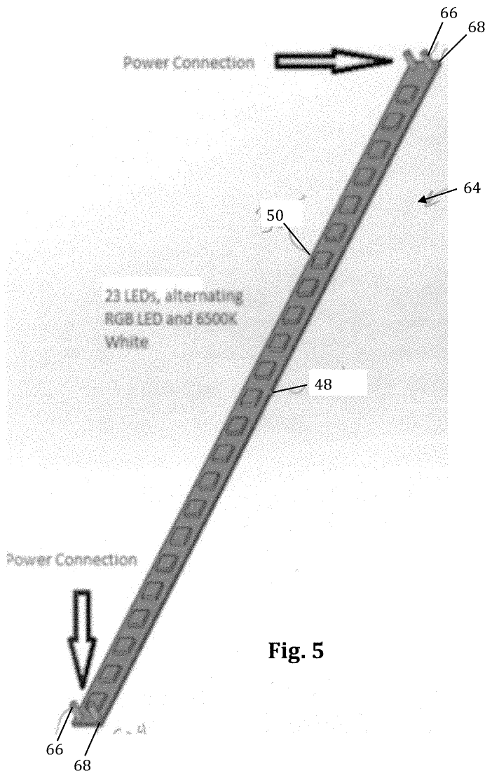

With reference now to FIG. 5, a perspective view of one embodiment of the second illumination feature 48 is shown. As seen in FIG. 5, the second illumination feature 48 can comprise an elongate member 64 that can comprise power connectors 66 at its ends 68. In some embodiments, one of these power connectors 66 can electrically connect the second illumination feature 48 to the LED PCB 46, and the other of these power connectors 66 can electrically connect the second illumination feature 48 to a portion of the greenhouse portion 14.

The second illumination feature 48 can comprise a plurality of illumination elements 50. In some embodiments, this plurality of illumination elements can comprise approximately 10 illumination elements 50, approximately 20 illumination elements 50, approximately 23 illumination elements 50, approximately 30 illumination elements 50, approximately 50 illumination elements 50, approximately 100 illumination elements 50, and/or any other or intermediate number of illumination elements 50. In some embodiments, the illumination elements 50 of the second illumination feature 48 can comprise alternating RGB LEDs and 6,500K LEDs.

In some embodiments, in which the first and second illumination features 46, 48 are controllably connected by the processor, the processor can selectively power some or all of the illumination elements 50 in the first and/or second illumination feature 46, 48 based on a detected size of a plant in the enclosed volume of the greenhouse portion.

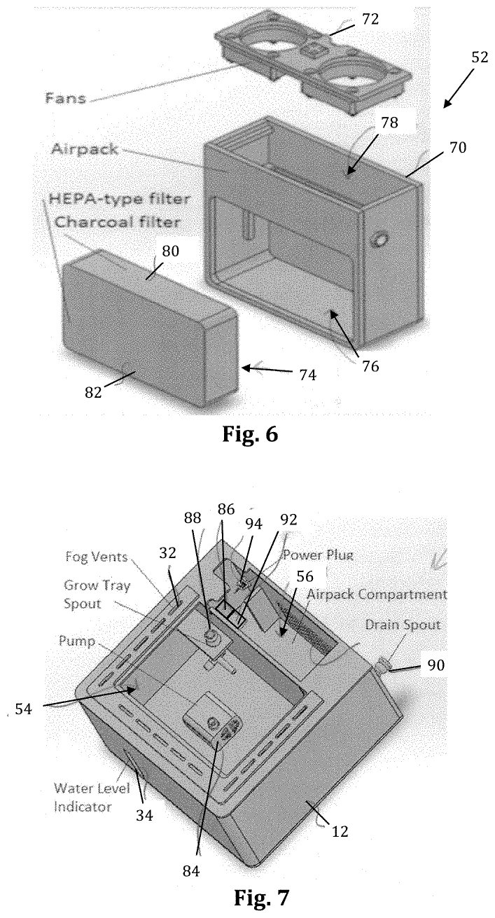

Returning again to FIG. 3, the system 10 can include a filtration member 52. In some embodiments, the filtration member 52 can obstruct one or both of the inlet aperture 36 and the outlet aperture 38 such that air flowing through the obstructed one or both of the inlet aperture 36 and the outlet aperture 38 passes through the filtration member 52. As seen in FIG. 3, the filtration member 52 can, in some embodiments, be received within a filter compartment 56 of the reservoir portion 12, and in some embodiments, the filtration member 52 can be a component of the greenhouse portion 14. The filtration member 52 is shown in greater detail in FIG. 6.

As seen in FIG. 6, the filtration member 52 can comprise a filter housing 70, one or several fans 72, and a filter member 74. The filter housing 70 can be sized and shaped to be received within the reservoir base 12 and can include an inlet 76 and an outlet 78. In some embodiments, when received within the reservoir base 12, the inlet 76 of the filter housing 70 can receive air from external to the greenhouse portion 14 and the outlet 78 of the filter housing 70 can be positioned adjacent to the inlet aperture 36 and can provide air to the inlet aperture 36.

The one or several fans 72 can comprise any component configured to move air through the greenhouse portion 14. In some embodiments, the one or several fans 72 can be electrically powered fans that can be controlled by the processor according to one or several parameters of the system 10 measured by one or several sensors associated with the system 10.

In some embodiments, the one or several fans 72 can be controlled by a processor 86 to control the velocity of air passing through the enclosed volume 26. In some embodiments, the processor 86 can control the one or several fans according to at least one of: a humidity level measured in the enclosed volume 26, a size of a plant in the enclosed volume 26, a weight of the plant in the enclosed volume 26, or a temperature level measured in the enclosed volume 26. In some embodiments, the velocity of the air can facilitate in the growth of a plant with a larger and/or thicker stem and/or in increasing the transport of nutrients to the leaves of the plant through the stem. In some embodiments, for example, the fans can be controlled to maintain a desired wind-speed, temperature, relative humidity, and/or the like through the greenhouse portion 14.

The filter member 74 can comprise a first component 80 and a second component 82. In some embodiments, the first component 80 can comprise a first filter element that can be, for example, an activated carbon filter element. In some embodiments, the second components 82 can comprise a second filter element that can be, for example, a HEPA filter element. In some embodiments, the filter member 74 including the first and second components 80, 82 can be received and/or contained within the inlet of the filter housing 70.

Returning again to FIG. 3, the reservoir portion 12 can further include a reservoir 54. In some embodiments, the reservoir 54 can be configured to receive and hold a liquid such as, for example, water including water with fertilizer. In some embodiments, the water level indicator 34 can provide an indicator of the level of the water inside of the reservoir 54 of the reservoir portion 12.

A perspective view of one embodiment of the reservoir portion 12 is shown in FIG. 7. As shown by way of example, the reservoir portion 12 includes the reservoir 54, the water level indicator 34, the filter compartment 56, plurality of apertures 32 extending through the top 16 of the reservoir portion 12 and into the reservoir 54, and a drain spout 90. The reservoir portion 12 can further include a pump 84 that can be configured to pump water or other liquid from the reservoir 54 to the grow tray 28. In some embodiments, the processor 86 can control the rate of water or other liquid pumped by the pump. In some embodiments, this processor 86 can be configured to receive data from one or more of the components of the system 10 and to provide control signals to one or more components of the system 10.

The processor 86 may be implemented as one or more integrated circuits (e.g., a conventional microprocessor or microcontroller). One or more processors, including single core and/or multicore processors, may be included in processing unit. The processing unit may be implemented as one or more independent processing units and/or with single or multicore processors and processor caches included in each processing unit. In other embodiments, processing unit may also be implemented as a quad-core processing unit or larger multicore designs (e.g., hexa-core processors, octo-core processors, ten-core processors, or greater).

The pump 84 can be fluidly connected to the grow tray 28 via a spout 88 and/or one or several hoses extending from the pump 84 to the spout 88 and/or from the spout 88 to the grow tray 28.

The reservoir portion 12 can further include the filter compartment 56 which can house the processor 86, a communications module 92, and a power module 94. In some embodiments, the processor 86 can be configured to control the operation of the system 10 according to computer code which can be, for example, stored in memory accessible by the processor 86. In some embodiments, the communications module 92 can be configured to send data to a user device and receive data from the user device. In some embodiments, the user can, via communication with the system 10 by the communications module 92, affect the operation of the system 10. The communications module 92 can be configured to communicate via a wired and/or wireless connection with the user device via one or several communications protocols or standards. The power module 94 can be configured to power the system 10 and can include, for example, one or several plugs, energy storage devices such as batteries, connectors, or the like.

In some embodiments, for example, the user can receive data from one or several sensors electrically connected with the processor 86. In some embodiments, this data can characterize, for example, an attribute of the enclosed volume 26 such as, for example, a temperature of the enclosed volume 26, a relative humidity of the enclosed volume 26, a hydration level in the grow tray 28, a wind velocity through the enclosed volume 26, a plant size and/or weight of the plant growing in the enclosed volume 26, illumination data characterizing the illumination of the plant growing in the enclosed volume 26, or the like. In some embodiments this data can characterize, for example, an attribute of the system 20 such as, for example, a water level in the reservoir 54, a turbidity of the water in the reservoir 54, a temperature of the water in the reservoir 54, a filter status, or the like.

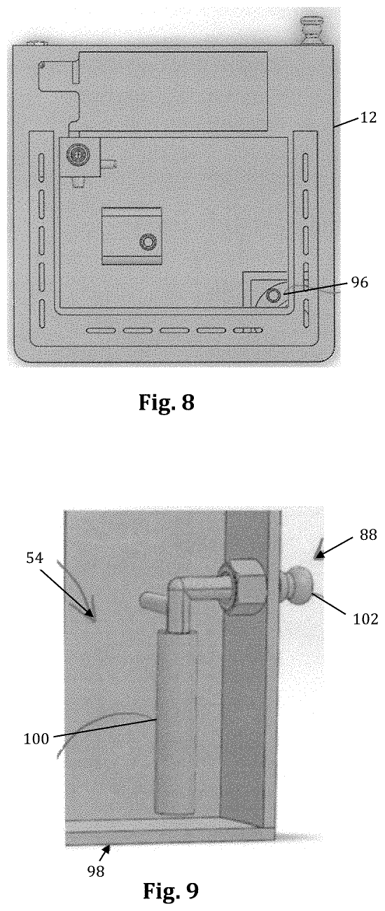

With reference now to FIG. 8, a top view of the reservoir portion 12 is shown. The reservoir portion 12 can further include a humidifying element 96 located in the reservoir 54, and specifically in the bottom of the reservoir 54. The humidifying element 96 can be configured to add water to the air in the enclosed volume 26 via the apertures 32. In some embodiments, the humidifying element 96 can comprise a mist or fog generator such as, for example, an ultrasonic droplet generator.

With reference now to FIG. 9, a side view of one embodiment of the drain spout 90 is shown. In some embodiments, the drain spout 90 can include a straw portion 100 extending towards the bottom 98 of the reservoir 54 and an outlet portion 102 extending to the outside of the reservoir portion 12. In some embodiments, the extending of the straw portion 100 towards the bottom 98 of the reservoir 54 can facilitate the removal of water relatively more proximate to the bottom 98 of the reservoir 54 before the removal of water relatively less proximate to the bottom 98 of the reservoir 54. In some embodiments, this can advantageously result in the removal of older water containing higher particulate levels and/or old fertilizer first. In some embodiments, the positioning of the drain spout 90 relative to the bottom 98 of the reservoir 54 can facilitate the siphoning of liquid out of the reservoir 54 until the liquid level is at the level of the outlet portion 102.

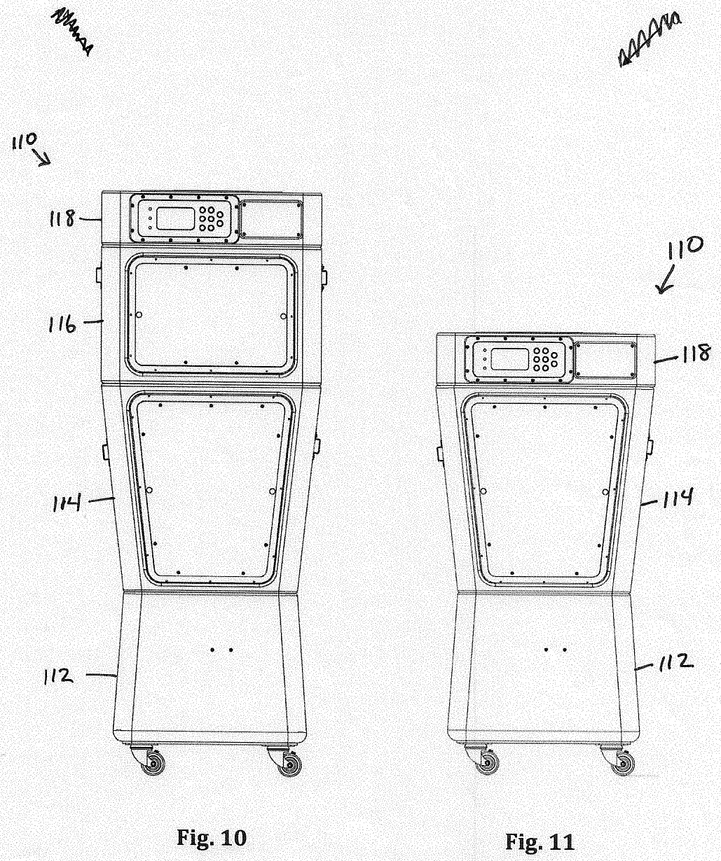

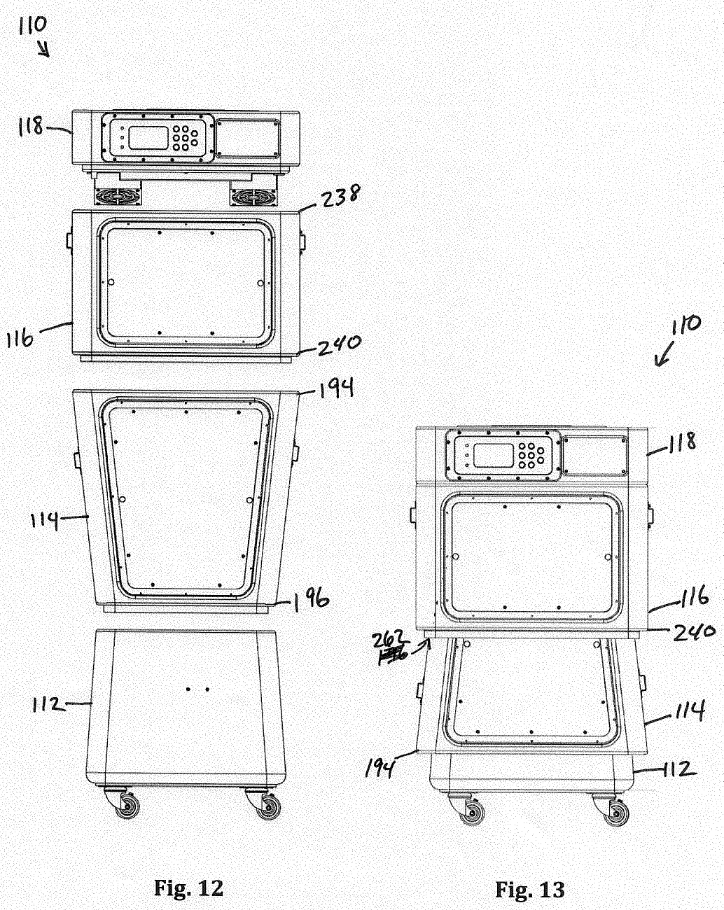

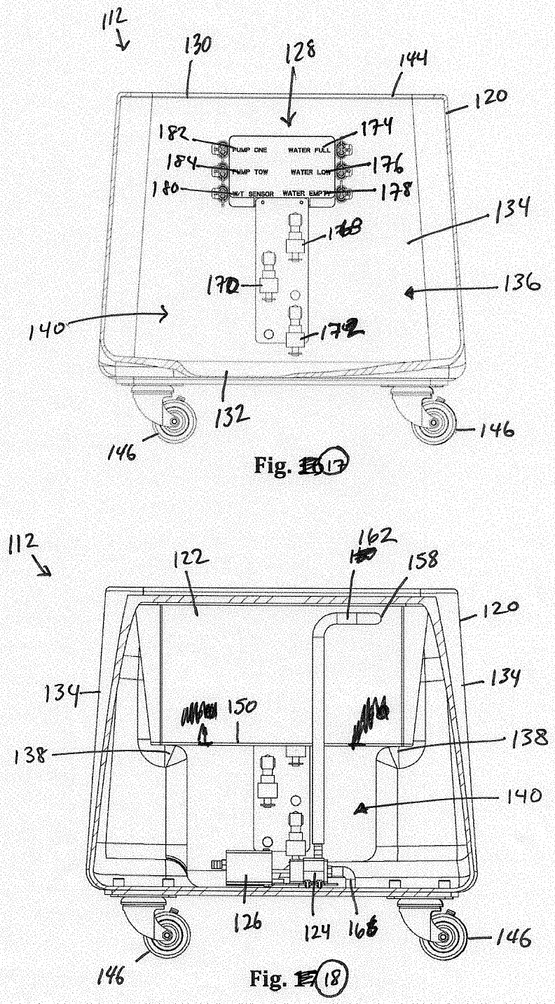

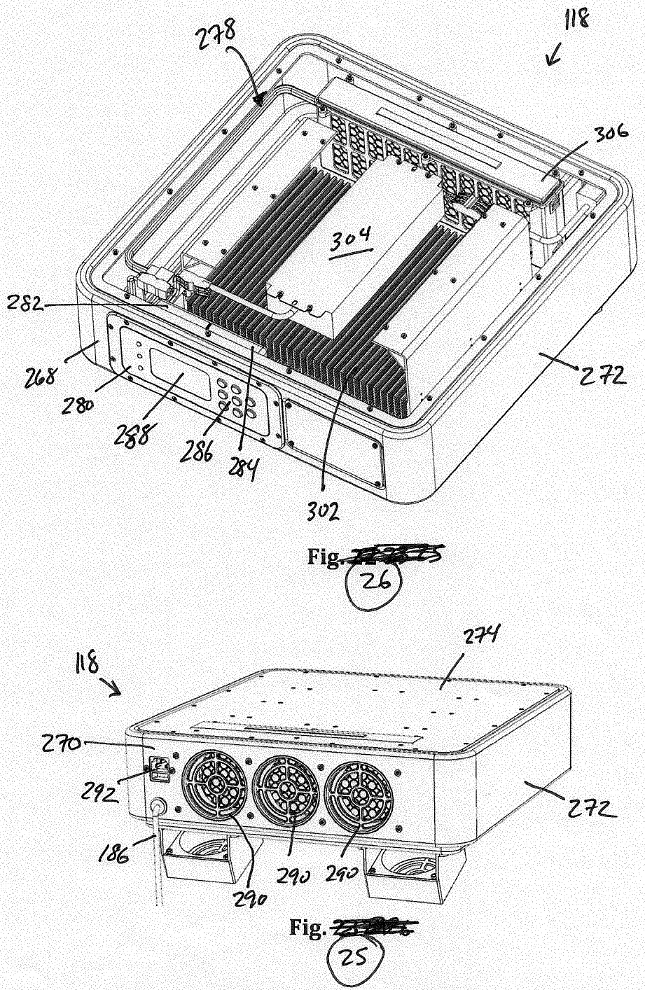

FIGS. 10-28 illustrate an example of a portable modular hydroponic grow box 110 according to another embodiment of the disclosure. The modular hydroponic grow box 110 has many features in common with the hydroponic grow box 10 described above, and it should be understood that the modular hydroponic grow box 110 described herein may include any feature or element of the hydroponic grow box 10 described by way of example above without limitation.

By way of example, the modular hydroponic grow box 110 includes a base unit 112, a first greenhouse module 114, a second green house module 116, and a control unit 118, as shown in FIG. 10. In some embodiments, the modular hydroponic grow box 110 may have more or less than the two greenhouse modules 114, 116 shown in FIG. 10. In some embodiments, the modular hydroponic grow box 110 may include only one greenhouse module 114, as shown by way of example in FIG. 11. In such embodiments, the single greenhouse module preferably has the inverted pyramidal frustum shape of the first greenhouse module 114, described below. In some embodiments, the modular hydroponic grow box 110 may include three or more greenhouse modules. In such embodiments, the additional greenhouse modules (e.g. third greenhouse module, fourth greenhouse module, etc.) preferably have the cube shape of the second greenhouse module 114. In some embodiments, the additional greenhouse modules may be added to the stack if needed as a plant grows. The modular configuration of the grow box 110, as well as the various shapes of the components, allow for a customizable growing experience and ease of disassembly for compact storage and shipping (FIG. 13).

In some embodiments, the various components of the modular grow box 110 are configured to removably stack on top of one another. In some embodiments, the base unit 112 comprises the bottom of the component stack. In some embodiments, the first greenhouse module 114 is stacked immediately on top of the base unit 112. In some embodiments, the second module 116 is stacked immediately on top of the first greenhouse module 114. In some embodiments, the control unit 118 is stacked immediately on top of the highest greenhouse module (e.g. second greenhouse module 116 in FIG. 10 and/or first greenhouse module in FIG. 11), and comprises the top layer of the component stack.

FIGS. 15-18 illustrate an example of a base unit 112 according to one embodiment of the disclosure. By way of example only, the base unit may include a housing 120, a grow tray 122, a fill pump 124, a circulating pump 126, and a water level monitoring system 128. The housing 120 includes a top 130, a bottom 132, and a plurality of vertically oriented walls 134 defining the outer perimeter of the housing 120 and an inner cavity 136 within the housing 120. The inner cavity 136 is sized and configured to receive the grow tray 122 therein as well the other components of the base unit 112. The grow tray 122 may be placed upon a pair of lateral protrusions or ledges 138 extending into the inner cavity 136 from opposing walls 134 such that the grow tray 122 occupies an upper portion of the inner cavity 136. The lower portion of the inner cavity 136 (e.g. below the bottom of the grow tray) comprises a water reservoir 140. The water reservoir 140 is configured to hold the water (and any added nutrients, minerals, fertilizer, etc.) that is pumped from the reservoir 140 into the grow tray 122 to provide nourishment to a plant contained in the grow tray 122.

In some embodiments, the top 130 of the housing 120 comprises an aperture or opening 142 such that no physical barrier exists between the base unit 112 and first greenhouse module 114. In some embodiments, the top 130 of the housing 120 comprises a rim 144 configured to sealingly mate with the bottom 196 of the first greenhouse module 114 such that the vertical lip 230 of the first greenhouse module 114 extends through the aperture 142 flushly against the rim 144 to prevent relative movement between the first greenhouse module 114 and base unit 112 once mated. Since the housing 120 has an “open” top 130 due to the aperture 142, the housing 120 and by extension the water reservoir 140 is fluidly or pneumatically connected to the interior volume 198 of the first greenhouse module 114. Thus in some embodiments, the top aperture 142 can allow fog or mist to rise from the water reservoir 140 of the housing 120 into the interior volume 198 of the first greenhouse module 114.

In some embodiments the walls 134 taper inward such that the base unit 112 has a pyramidal frustum shape (having a trapezoidal cross-section) wherein the top 130 of the housing 120 comprises the minor base of the pyramidal frustum and the bottom 132 comprises the major base of the pyramidal frustum, as shown in FIG. 10. As used herein, “pyramidal frustum” is defined as a pyramid in which the apex has been removed by a cut parallel to the plane of the base of the pyramid, resulting in truncated pyramid having a major base (formerly the base), a minor base that is parallel to the major base (resulting from the planar cut that removed the apex), and a trapezoidal cross-sectional shape. In some embodiments the walls 134 may be vertical such that the base unit 112 has a cube shape. In some embodiments, the base unit 112 has four walls 134, as shown in FIG. 10. In some embodiments, the base unit 112 may have more or less than four walls, however the number of walls of the base unit 112 should preferably coincide with the number of walls of the first greenhouse module 114.

In some embodiments, the housing 120 may be provided with one or more surface interface elements 146 positioned on the exterior surface of the bottom 132 of the housing 120, for providing an interface between the hydroponic grow box 110 and a surface upon which the hydroponic grow box 110 is set (e.g. floor, tabletop, countertop, dresser, desk, etc.) In some embodiments, the one or more surface interface elements 146 comprise a friction element that discourages movement (e.g. rubber “feet”). In some embodiments, the one or more surface interface elements 146 comprise an element that encourages at least some movement (e.g. lockable castors as shown in FIGS. 15-17).

By way of example only, the grow tray 122 may comprise a generally rectangular shaped container having a top 148, a bottom 150, and a plurality of walls 152 extending vertically between the top 148 and bottom 150 and defining an inner cavity 154 of the grow tray 122. The top 148 includes a large aperture 156 configured such that the top of the grow tray 122 is mostly open to the inner cavity 154. In some embodiments, the inner cavity 154 may comprise one or several portions for receiving and/or containing seeds and/or root media. In some embodiments, these one or several portions can comprise one or several troughs. In some embodiments, the root media can comprise a granular material such as sand, gravel, pebbles, clay balls, beads, glass beads, or the like. The aperture 156 allows a plant rooted within the inner cavity 154 to grow out of the grow tray 122. As previously mentioned the grow tray 122 occupies the upper portion of the inner cavity 136 of the housing 112, and thus the top 148 of the grow tray 122 is positioned proximate the top aperture 142 of the housing 120 and bottom aperture 228 of the first greenhouse module 114 such that a plant rooted within inner cavity 154 of the grow tray 112 may grow into the interior volume 198 of the first greenhouse module 114.

The grow tray 122 may comprise a variety of shapes and sizes and can be made from a variety of materials. In some embodiments, the grow tray can comprise a polymer, a foam, or the like. In some embodiments, the grow tray 122 can comprise a water permeable material. In some embodiments, the grow tray 122 can comprise a water inlet 158 and a water outlet 160. In some embodiments, the water inlet 158 can be connected to a water delivery device (e.g. fill pump 124 by way of flexible tube 162) and the water outlet 160 can be fluidly connected to the reservoir 140 of the housing 120 such that any excess water can return to the reservoir 140. By way of example only, the water inlet 158 of the current embodiment comprises an aperture 158 positioned on one of the walls 152 near the top 148 of the grow tray 122. The water inlet/aperture 158 is fluidly connected to the fill pump 124 by a flexible tube 162. The water outlet 160 comprises one or more drain apertures 160 formed within the bottom 150 of the grow tray 122, and in that way is fluidly connected to the reservoir 140. In some embodiments, the grow tray 122 further comprises a plurality of overflow apertures 164 positioned on at least one of the walls 152 that does not include the inlet aperture 158 to prevent overfill of the grow tray 122 by allowing excess water to drain into the reservoir 140.

In some embodiments, the grow tray 122 can be associated with one or several sensors. In some embodiments, these sensors can include, for example, a moisture sensor configured to determine a moisture level in the grow tray 122, a scale configured to determine the weight of the plant growing from the grow tray, or the like.

In some embodiments, the hydroponic grow box 110 of the present example is equipped with an ebb and flow hydroponics system. By way of example, the fill pump 124 is positioned within the water reservoir 140 near the bottom 132 of the housing 120. The fill pump 124 includes an intake tube 166 configured to receive water from the reservoir 140 which is then passed through the fill pump 124 and flexible tube 162 into the grow tray 122 as described above. This occurs at regular intervals that are programmable by way of the control panel 280 of the control unit 118. The water that is pumped into the grow tray 122 seeps through the root media, where at least some of the water is absorbed by the roots of the plant in the grow tray 122. The excess water passes through the root media and outlet apertures 160 where it returns to the reservoir 140.

In some embodiments, the hydroponic grow box 110 may further include a circulating pump 126. By way of example, the circulating pump 126 is positioned within the water reservoir 140 near the bottom 132 of the housing 120. In some embodiments, the circulating pump has a water inlet and a water outlet. The circulating pump creates a current within the water reservoir 140 to help keep the water aerated and also mix any fertilizer and/or other additives that might be added to the water in the reservoir 140 to aid in plant growth.

The housing 120 can further include a water level monitoring system 128 that can be, for example, associated with one or more water level sensors. In some embodiments, the water level monitoring system 128 can provide an indicator of the level of the water inside of the water reservoir 140 of the housing 120. In some embodiments, the indicator can comprise a visual indicator such as, for example, one or several Light Emitting Diodes (LED) that can change illumination and/or color based on the water level in the reservoir. By way of example, the water level monitoring system 128 of the current embodiment has a first sensor 168 (e.g. float switch) to detect when the level in the water reservoir 140 is too full, a second sensor 170 (e.g. float switch) to detect when water level in the water reservoir 140 is low, and a third sensor 172 (e.g. float switch) to detect when the water reservoir 140 is empty. In some embodiments, these sensors may communicate the information to the appropriate indicators that illuminate when prompted by the sensors (e.g. “Water Full” indicator 174, “Water Low” indicator 176, “Water Empty” indicator 178).

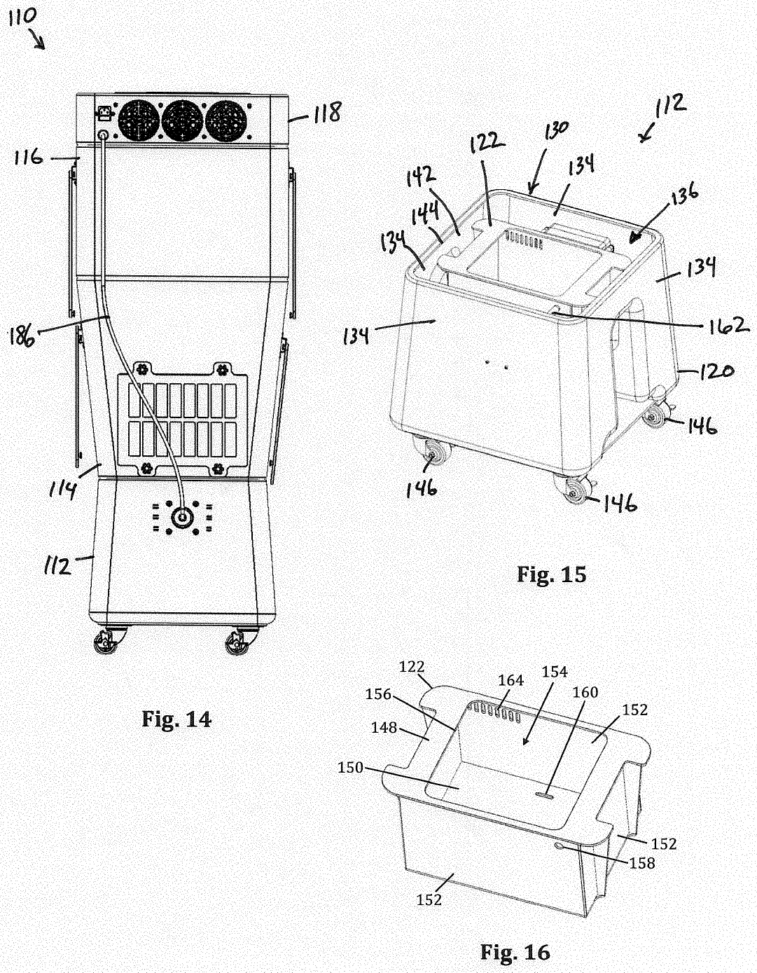

In some embodiments, the water reservoir 140 can further include one or several sensors configured to detect and/or monitor an attribute of the water in the reservoir 140. In some embodiments, this can include, for example, a turbidity sensor configured to measure the turbidity of the water in the reservoir portion 140, and then communicate turbidity information to an indicator (e.g. “W/T indicator 180) which lights up if the water temperature sensor detects water temperature past a certain threshold, which indicates to the user that the water should be changed in the reservoir 140. In some embodiments, the water reservoir 140 can further include one or several illuminated indicators that light up when one or more of the pumps are operating (e.g. “Pump One” indicator 182 which lights up when the fill pump 124 is in operation, and “Pump Two” indicator 184 which lights up when the circulating pump 126 is in operation). In some embodiments, a power cable 186 extends between the power module 304 of the control unit 118 and the monitoring system 128 of the base unit 112. In some embodiments, the power cable 186 extends externally along the back side of the hydroponic grow box 110, as shown by way of example in FIG. 14.

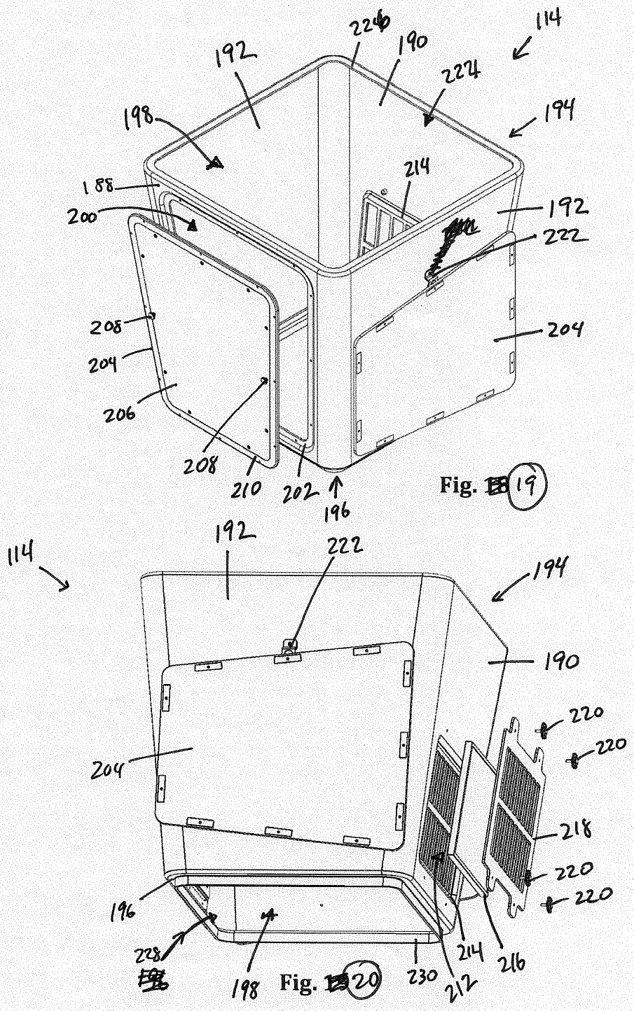

FIGS. 19-20 illustrate an example of a first greenhouse module 114 according to one embodiment of the disclosure. The first greenhouse module 114 comprises a front wall 188, a back wall 190, and a pair of side walls 192, with each of the various walls extending between a top 194 of the first greenhouse module 114 and a bottom 196 of the first greenhouse module 114. In some embodiments, one or several of the plurality of walls can be translucent, opaque, and/or reflective.

In some embodiments, the top 194 and bottom 196 of the first greenhouse module 114 are open, enabling unobstructed air flow and plant growth from the base unit 112 through the first greenhouse module 114 and into the second greenhouse module 116 (if present). The plurality of walls 188, 190, 192, the top 194, and the bottom 196 of the first greenhouse module 114 can together define an interior volume 198 that can be sized and shaped to receive and grow a plant. In a preferred embodiment, each of the plurality of walls 188, 190, 192 are angled away from the interior volume 198 such that the area of the top 194 is greater than the area of the bottom 196. This results in the first greenhouse module 114 having an inverted pyramidal frustum shape (having a trapezoidal cross-section), wherein the top 194 comprises the major base of the pyramidal frustum and the bottom 196 comprises the minor base of the pyramidal frustum. This inverted pyramidal frustum shape is advantageous in that it allows the interior volume 198 to increase as the first greenhouse module 114 increases in height, giving plants growing within the hydroponic grow box 110 more volume to grow into. Furthermore, the inverted pyramidal frustum shape is critical in enabling the collapsed configuration of the hydroponic grow box 110 shown in FIG. 13 and described in further detail below.

In some embodiments, the front wall 188 includes an access opening 200 extending therethrough and providing a user access to the plant (e.g. to harvest leaves, flowers, seeds, etc.) and the base unit 112 (e.g. to add water and/or fertilizer to the reservoir 140, and remove water from the reservoir 140, etc.). The access opening 200 may be provided in any useful size. By way of example only, the access opening 200 as shown in the current embodiment comprises a substantial portion of the front wall 188. In some embodiments, the access opening 200 is surrounded by a magnetic frame 202 defining the perimeter of the access opening 200. In some embodiments, a cover 204 may be provided that is sized and configured to fully obstruct and seal the access opening 200. By way of example, the cover 204 comprises a panel 206 including one or more handle elements 208 and surrounded by a frame 210 defining the outer perimeter of the cover 204. In some embodiments, the panel 206 may be translucent, opaque, and/or reflective. The frame 210 magnetically couples with the magnetic frame 202 so that the panel 206 may obstruct and seal the access opening 200. The magnetic interaction between the magnetic frame 202 and the cover 204 is advantageous in that it is relatively easy for a user to manipulate. Other cover configurations are possible within the scope of the present disclosure, including but not limited to (and by way of example only) a hinged cover with a latch/lock.

In some embodiments, the back wall 190 may include an inlet aperture 212 and a filter assembly obstructing the inlet aperture 212. The inlet aperture 212 is sized and configured to allow the flow of air from the outside of the first greenhouse module 114 to the interior volume 198 of the first greenhouse module 114. In some embodiments, the filter assembly includes a housing 214 sized and configured to hold an air filter 216 therein. A slotted panel 218 is positioned over the exterior portion of the inlet aperture 212 to hold the air filter 214 in place and secured to the first greenhouse module 114 by way of a plurality of fasteners 220 (for example). As will be explained below, air is pulled into the interior volume 198 through the inlet aperture 212 (and filter assembly) and is eventually forced out of the control unit 112 through exhaust fans 290 (and an activated carbon exhaust filter 308).

In some embodiments, at least one of the side walls 192 includes a hanger 222 configured to hold a cover 204 when not in use, for example when the user wants to access the interior volume 198 or to store an extra cover 204.

As previously mentioned, the top 194 and bottom 196 are both open. Thus in some embodiments, the top 194 of the first greenhouse module 114 comprises an aperture or opening 224 such that no physical barrier exists between the first greenhouse module 114 and second greenhouse module 116. In some embodiments, the top 194 of the first greenhouse module 114 comprises a rim 226 configured to sealingly mate with the bottom 240 of the second greenhouse module 116 such that the vertical lip 264 of the second greenhouse module 116 extends through the aperture 224 flushly against the rim 226 to prevent relative movement between the first greenhouse module 114 and second greenhouse module 116 once mated. In some embodiments, the bottom 196 of the first greenhouse module 114 comprises an aperture or opening 228 such that no physical barrier exists between the base unit 112 and first greenhouse module 114. In some embodiments, the bottom 196 of the first greenhouse module 114 comprises at least one vertical lip 230 configured to sealingly mate with the top 130 of the housing 112 such that the vertical lip 230 of the first greenhouse module 114 extends through the aperture 142 flushly against the rim 144 to prevent relative movement between the first greenhouse module 114 and base unit 112 once mated.

In some embodiments, the first greenhouse module 114 can comprise a plurality of sensors configured to detect one or several attributes of the first greenhouse module 114, the interior volume 198, and/or of the plant growing in the interior volume 198. By way of example, in some embodiments these sensors may include at least one of a light sensor, a humidity sensor positioned to measure the relative humidity of the air in the greenhouse portion, a temperature sensor to measure the air temperature, moisture sensor positioned to measure a moisture level in the grow tray, an oxygen sensor, a carbon dioxide sensor, and/or a plant size sensor. In some embodiments, the plant size sensor can comprise a scale, and in some embodiments, the plant size sensor can comprise an optical sensor.

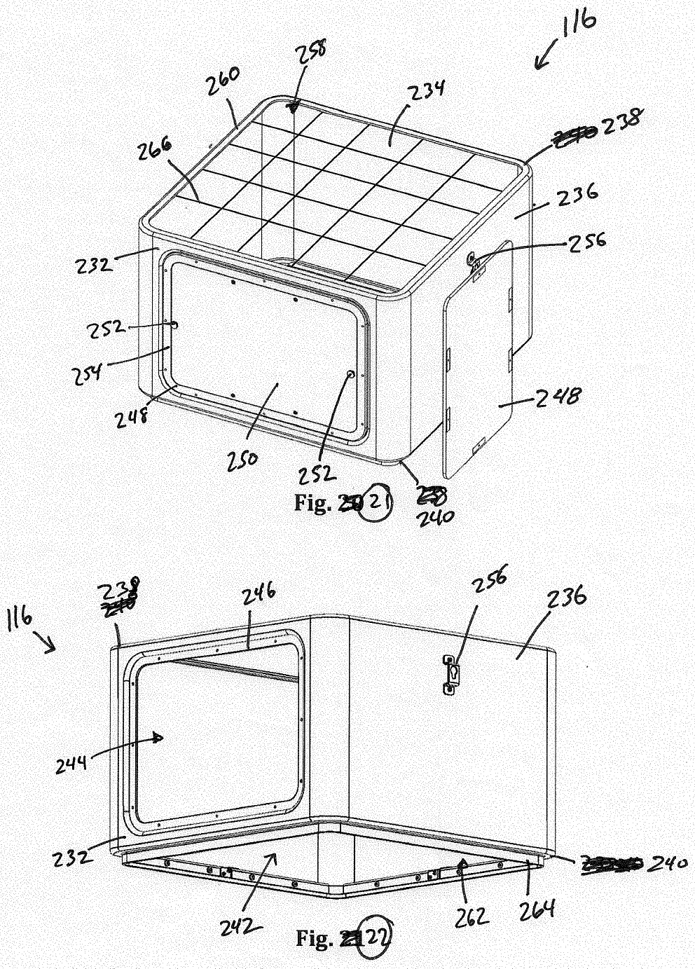

FIGS. 21-22 illustrate an example of a second greenhouse module 116 according to one embodiment of the disclosure. The second greenhouse module 116 comprises a front wall 232, a back wall 234, and a pair of side walls 236, with each of the various walls extending between a top 238 of the second greenhouse module 116 and a bottom 240 of the second greenhouse module 116. In some embodiments, one or several of the plurality of walls can be translucent, opaque, and/or reflective.

In some embodiments, the top 238 and bottom 240 of the second greenhouse module 116 are open, enabling unobstructed air flow and plant growth from the base unit 112 through the first greenhouse module 114 and into the second greenhouse module 116. The plurality of walls 232, 234, 236, the top 238, and the bottom 240 of the second greenhouse module 116 can together define an interior volume 242 that can be sized and shaped to receive and grow a plant. By way of example, each of the plurality of walls 232, 234, 236 are vertically oriented, resulting in the second greenhouse module 116 having general cubic shape.

In some embodiments, the front wall 232 includes an access opening 244 extending therethrough and providing a user access to the plant (e.g. to harvest leaves, flowers, seeds, etc.). The access opening 244 may be provided in any useful size. By way of example only, the access opening 244 as shown in the current embodiment comprises a substantial portion of the front wall 242. In some embodiments, the access opening 244 is surrounded by a magnetic frame 246 defining the perimeter of the access opening 242. In some embodiments, a cover 248 may be provided that is sized and configured to fully obstruct and seal the access opening 242. By way of example, the cover 248 comprises a panel 250 including one or more handle elements 252 and surrounded by a frame 254 defining the outer perimeter of the cover 248. In some embodiments, the panel 250 may be translucent, opaque, and/or reflective. The frame 254 magnetically couples with the magnetic frame 246 so that the panel 250 may obstruct and seal the access opening 242. The magnetic interaction between the magnetic frame 246 and the cover 248 is advantageous in that it is relatively easy for a user to manipulate. Other cover configurations are possible within the scope of the present disclosure, including but not limited to (and by way of example only) a hinged cover with a latch/lock.

In some embodiments, at least one of the side walls 236 includes a hanger 256 configured to hold a cover 248 when not in use, for example when the user wants to access the interior volume 244 or to store an extra cover 248.

As previously mentioned, the top 238 and bottom 240 are both open. Thus in some embodiments, the top 238 of the second greenhouse module 116 comprises an aperture or opening 258 such that no physical barrier exists between the second greenhouse module 116 and bottom 276 of the control unit 118, maximizing light exposure to the plant. In some embodiments, the top 238 of the second greenhouse module 240 comprises a rim 260 configured to sealingly mate with the raised platform 294 of the bottom 276 of the control unit 118 such that the raised platform 294 of the control unit 118 extends through the aperture 258 flushly against the rim 260 to prevent relative movement between the second greenhouse module 116 and control panel 118 once mated. In some embodiments, the bottom 240 of the second greenhouse module 116 comprises an aperture or opening 262 such that no physical barrier exists between the second greenhouse module 116 and first greenhouse module 114. In some embodiments, the bottom 240 of the second greenhouse module 116 comprises at least one vertical lip 264 configured to sealingly mate with the top 194 of the first greenhouse module 114 such that the vertical lip 264 of the second greenhouse module 116 extends through the aperture 224 flushly against the rim 226 to prevent relative movement between the second greenhouse module 116 and first greenhouse module 114 once mated.

In some embodiments, the second greenhouse module 116 can comprise a plurality of sensors configured to detect one or several attributes of the second greenhouse module 116, the interior volume 242, and/or of the plant growing in the interior volume 242. By way of example, in some embodiments these sensors may include at least one of a light sensor, a humidity sensor positioned to measure the relative humidity of the air in the greenhouse portion, a moisture sensor positioned to measure a moisture level in the grow tray, an oxygen sensor, a carbon dioxide sensor, and/or a plant size sensor. In some embodiments, the plant size sensor can comprise a scale, and in some embodiments, the plant size sensor can comprise an optical sensor.

In some embodiments, at least one of the first greenhouse module 114 and second greenhouse module may include a trellis 266 or scaffolding extending across a top portion thereof. The trellis 266 may be provided to encourage the top of the plant to grow thereon to increase total exposure to the grow light.

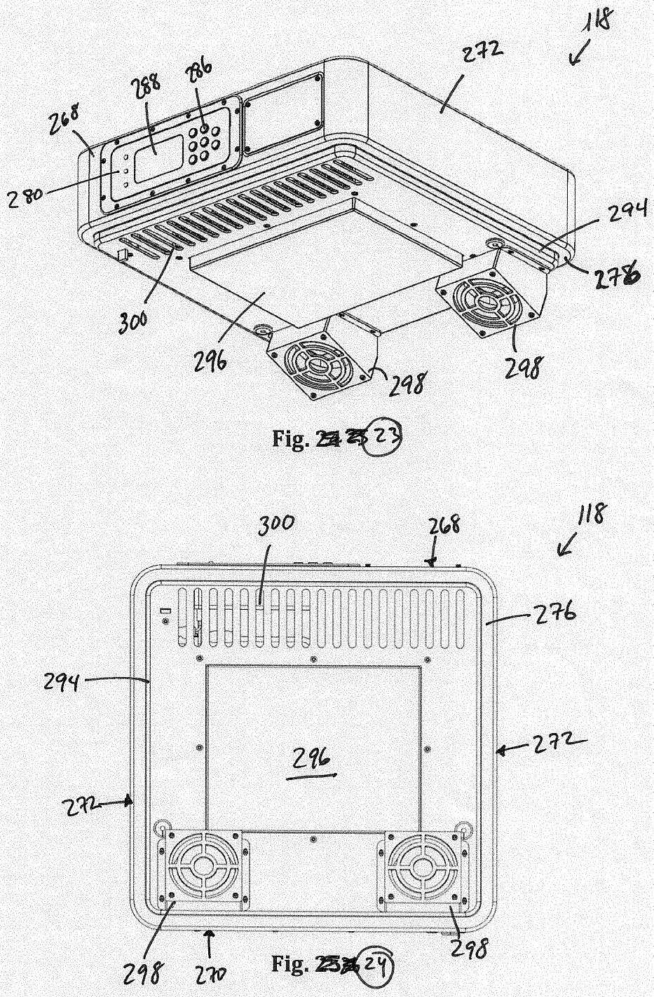

FIGS. 23-26 illustrate an example of the control unit 118 according to one embodiment of the disclosure. By way of example, the control unit 118 comprises a front wall 268, a back wall 270, and a pair of side walls 272, with each of the various walls extending between a top 274 of the control unit 118 and a bottom 276 of the control unit 118. The plurality of walls 268, 270, 272, the top 274, and the bottom 276 of the control unit 118 can together define an interior cavity 278 that various features described below.

In some embodiments, the front wall 268 includes a control panel 280. By way of example, the control panel 280 comprises a processor 282, communications module 284, user input feature 286, and a display 288. In some embodiments, the processor 282 can be configured to receive data from one or more of the components of the grow box 110 and to provide control signals to one or more components of the grow box 110. In some embodiments, the processor 282 can be configured to control the operation of the hydroponic grow box 110 according to computer code which can be, for example, stored in computer readable media (e.g. memory, etc.) accessible by the processor 282. In some embodiments, the communications module 284 can be configured to send and/or receive data to and/or from a user device (e.g. computer, smart phone, smart watch, personal digital assistant, tablet computer, etc.). In some embodiments, the user can, via communication with the control panel 280 by way of the communications module 284 and/or user input feature 286 and/or touch-screen enabled display 288, affect the operation of the grow box 110. The communications module 284 can be configured to communicate via a wired and/or wireless connection with the user device via one or several communications protocols or standards (e.g. Ethernet, Wifi, Bluetooth, etc.).

In some embodiments, for example, the user can receive data from one or several sensors electrically connected with the processor 282. In some embodiments, this data can characterize, for example, an attribute of the interior volume 198, 242 such as, for example, a temperature of the interior volume 198, 242, a relative humidity of the interior volume 198, 242, a hydration level in the grow tray 122, a wind velocity through the interior volume 198, 242, a plant size and/or weight of the plant growing in the interior volume 198, 242, illumination data characterizing the illumination of the plant growing in the interior volume 198, 242, and the like. In some embodiments this data can characterize, for example, an attribute of the grow box 110 such as, for example, a water level in the reservoir 140, a turbidity of the water in the reservoir 140, a temperature of the water in the reservoir 140, pH of the water in the reservoir 140, total dissolved solids in the reservoir 140, filter status, and the like.

In some embodiments, the user can input instructions to the processor 282 by way of the user input feature 286 of the control panel 280 (and/or connected user device) in response to the received data to affect a change in operation of the grow box 110 to achieve a desired outcome. In some embodiments, a user can proactively affect a change in the operation of the grow box 110 to achieve a desired outcome by communicating with the processor via the user input feature 286 (shown by way of example as a plurality of buttons 286 and/or touch-screen interface on the display 288). In some embodiments, the user may initiate a “Change water mode” by pressing a input button 286 to select the mode and then indicate that a bucket is present and the flexible tube 162 has been detached from the water inlet 158 of the grow tray 122 and positioned in said bucket. The processor 282 causes the fill pump 124 to activate, pumping water from the reservoir into the bucket. When the “Water Empty” float sensor 172 triggers, the processor 282 causes the fill pump 124 to turn off.

In some embodiments, the processor 282 can be programmed with instructions to automatically respond to certain data thresholds (e.g. too warm, too humid, etc.) to affect a change in the operation of the grow box 110 to achieve a desired outcome. In some embodiments, the processor 282 can be programmed with instructions to control operations according to a specific schedule. For example, in some embodiments, the processor 282 can control the rate of water or other liquid pumped by the fill pump 124 and/or circulating pump 126 (e.g. adhere to a pump schedule). In some embodiments, the processor 282 can be programmed to adhere to a particular lighting schedule (e.g. 12 hours on, 12 hours off in “Flower” mode, 16 hours on, 8 hours off in “Grow” mode). In some embodiments, the exhaust fans 290 and/or the circulating fans 298 may also be programmed to operate according to a specific schedule.

The processor 282 may be implemented as one or more integrated circuits (e.g., a conventional microprocessor or microcontroller). One or more processors, including single core and/or multicore processors, may be included in processing unit. The processing unit may be implemented as one or more independent processing units and/or with single or multicore processors and processor caches included in each processing unit. In other embodiments, processing unit may also be implemented as a quad-core processing unit or larger multicore designs (e.g., hexa-core processors, octo-core processors, ten-core processors, or greater).

In some embodiments, the back wall 270 includes one or several exhaust fans 290, power coupling 292 configured to receive one end of a A/C or D/C power cord (e.g. for plugging into a wall outlet), and one end of the power cable 186 that connects the base unit 112 to the power module 304.

The one or several fans 290 can comprise any component configured to move air through the greenhouse modules 114, 116. In some embodiments, the one or several fans 290 can be electrically powered fans that can be controlled by the processor 282 according to one or several parameters of the grow box 110 measured by one or several sensors associated with the grow box 110. In some embodiments, the one or several fans 290 can be controlled by the processor 282 to control the velocity of air passing through the interior volume 198/242 of the first and second greenhouse modules 114, 116. In some embodiments, the processor 282 can control the one or several fans according to at least one of: a humidity level measured in the interior volume 198/242, a size of a plant in the interior volume 198/242, a weight of the plant in the interior volume 198/242, or a temperature level measured in the interior volume 198/242. In some embodiments, the velocity of the air can facilitate in the growth of a plant with a larger and/or thicker stem and/or in increasing the transport of nutrients to the leaves of the plant through the stem. In some embodiments, for example, the fans can be controlled to maintain a desired wind-speed, temperature, relative humidity, and/or the like through the first and second greenhouse modules 114, 116.

In some embodiments the bottom 276 includes a raised platform 294 including a lighting component 296, one or more circulation fan 298, and a plurality of air vents 300 to allow airflow from the interior volume 198/242 to the inner cavity 278 of the control unit 118. The raised platform 294 is sized and configured to sealingly mate with the top 238 of the second greenhouse module 116 (or the top 194 of the first greenhouse module 114 in a single-greenhouse configuration) such that the raised platform 294 of the control unit 118 extends through the top aperture 258 flushly against the rim 260 to prevent relative movement between the second greenhouse module 116 and control unit 118 once mated.

In some embodiments, the lighting component 296 can comprise a variety of shapes and sizes and be attached to the bottom 276 of the control unit 118, which is positioned at the top of the module stack. By way of example only, the lighting component 296 comprises LED lighting like the lighting described above with respect to the hydroponic grow box 10, and a repeat discussion of the specific features thereof is not necessary. In some embodiments, the lighting component 296 can be controlled to selectively illuminate all or portions of the interior volume 198/242 and/or the plant growing within the interior volume 198/242. In some embodiments, the lighting component 296 can comprise a plurality of illumination elements, which can generate electromagnetic radiation in response to receipt of a current. In some embodiments, these illumination elements can comprise one or several lights, light bulbs, LEDs, or the like. The illumination elements can comprise a single type of illumination element, and in some embodiments, the illumination elements can comprise a plurality of types of illumination elements. In some embodiments, some or all of the types of illumination elements can generate different wavelengths of electromagnetic radiation, generate different powers of electromagnetic radiation, or the like.

In some embodiments, the processor 282 can control some or all of the illumination elements to achieve a desired illumination. In some embodiments this can include providing illumination with one or several desired wavelengths, ratio of wavelengths, or the like. In some embodiments, providing a desired illumination can include selectively powering illumination elements based on a detected size of the plant in the interior volume 198/242. In some embodiments, this can include the processor 282 determining the size of the plant in the interior volume 198/242, the processor selecting the illumination elements corresponding to the detected size of the plant in the interior volume 198/242, and the processor powering the selected illumination elements.

In some embodiments, the circulating fans 298 are oriented at an angle such that the airflow from the circulating fans 298 may be directed across the prevailing airflow driven by the exhaust fans 290, creating better airflow within the grow box 110. The circulating fans may be controlled by the processor, and may be on an automatic schedule or may be activated manually by a user.

In some embodiments, the air vents 300 are located on the bottom 276 of the control unit proximate the front side 268. This ensures that the airflow driven by the exhaust fans 290 occurs diagonally from back to front.

In some embodiments the inner cavity 278 includes an LED heatsink 302, power module 304, and filter unit 306. The LED heatsink 302 is provided to help cool the LED lighting component 296. The power module 304 can be configured to power the growbox 110 and can include, for example, one or several plugs, energy storage devices such as batteries, connectors, or the like. The filter unit 306 includes an activated carbon exhaust filter 308 which again filters the air as it is exiting the grow box 110, further cleaning the air circulated within the room that the hydroponic grow box 110 of the present example is located in.

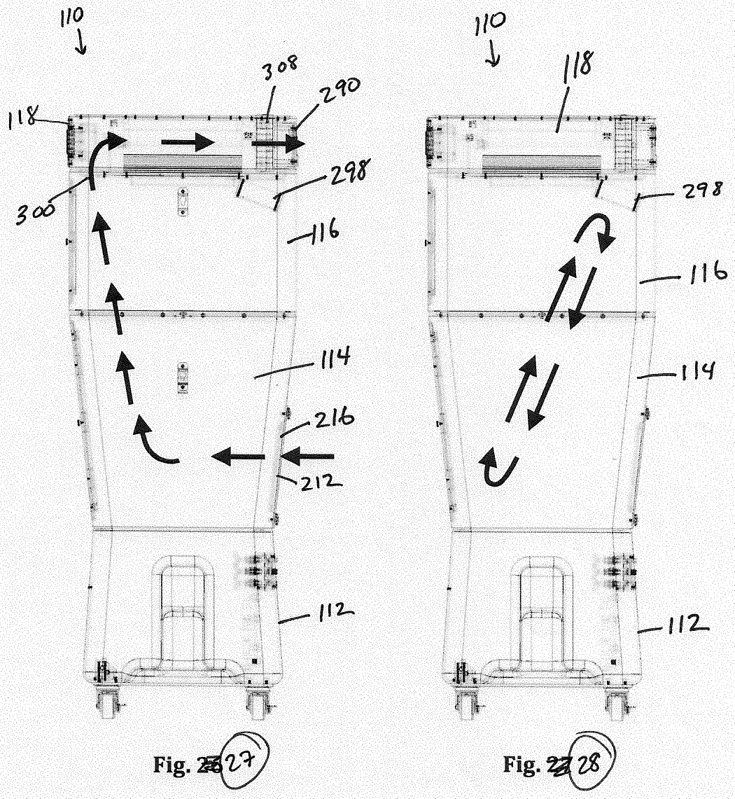

FIG. 27 illustrates an example of the air flow through the hydroponic grow box 110 as effectuated by the exhaust fans 290. In operation, the one or several fans 290 create a vacuum which causes air to be drawn into the first greenhouse module 114 through the inlet aperture 212 and filter 216. By way of example, filter 216 may be a particle intake filter. The air is pulled through the first and second greenhouse modules 114, 116 and through the air vents 300 in the control unit 118 and finally the activated carbon exhaust filter 308 on its way out through the exhaust fans 290.

FIG. 28 illustrates an example of the airflow pattern through the hydroponic grow box 110 effectuated by the circulating fans 298. Since the circulating fans 298 have an angled orientation, that the airflow (e.g. diagonally downward back-to-front) from the circulating fans 298 may be directed across the prevailing airflow (e.g. diagonally upward back-to-front) driven by the exhaust fans 290, creating better airflow within the grow box 110.

Referring again to FIG. 13, the collapsed configuration of the hydroponic grow box 110 is shown. This configuration is enabled by the pyramidal frustum shape of the first greenhouse module 114 in combination with the pyramidal frustum shape of the base unit 112. To collapse the hydroponic grow box 110 as shown, the first step is to unstack the components. Starting with the base unit 112 placed on a stable flat surface (e.g. floor, table, desk, etc.), the next step is to invert the first greenhouse module 114 and place over the base unit 112 such that the top 130 of the housing 120 (e.g. minor base of the base unit pyramidal frustum) passes through the top aperture 224 and into the interior volume 198 of the first greenhouse module 114. The base unit 112 is sized and shaped such that a substantial portion of the base unit 112 is received within the interior volume 198 of the first greenhouse module 114. The tapered sides of the base unit 112 allow greater penetration than would be feasible if the base unit 112 had vertical sides. Once the inverted first greenhouse module 114 has been seated on top of the base unit 112, the second greenhouse module 116 may be placed on over the inverted first greenhouse module 114 such that the bottom 196 of the first greenhouse module 114 (e.g. minor base of the pyramidal frustum) passes through the bottom aperture 262 and into the interior volume 242 of the second greenhouse module 116. Once the second greenhouse module 116 has been fully seated over the first greenhouse module 114, the control unit 118 may be placed on top of the second greenhouse module 116 as normal. This feature reduces the height of the grow box 110 and also significantly lowers the center of gravity, making the hydroponic grow box 110 of the present embodiment easier to store and transport.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

While the principles of the disclosure have been described above in connection with specific apparatuses and methods, it is to be clearly understood that this description is made only by way of example and not as limitation on the scope of the disclosure.

What is claimed is:

1. A stackable hydroponic greenhouse system, comprising:
a base unit including a water reservoir sized and configured to receive a volume of water therein, and a grow tray sized and configured to receive a volume of plant root media therein, the base unit comprising a housing element having a pyramidal frustum shape;
a first greenhouse module having four lateral walls, an open top end, an open bottom end, and a first interior volume defined by the space between the four lateral walls and top and bottom ends, the first greenhouse module having an inverted pyramidal frustum shape, the first greenhouse module configured to stack on top of the base unit;
a second greenhouse module having four lateral walls, a top end, an open bottom end, and a second interior volume defined by the space between the four lateral walls and top and bottom ends, the second greenhouse module configured to stack on top of the first greenhouse module; and
a control unit configured to stack on top of the second greenhouse module, the control unit including a control panel, a power module, a processor, and a lighting component.

2. The system of claim 1, wherein the base unit further comprises a fill pump configured to pump water from the water reservoir to at least one of the grow tray and a discard bucket.

3. The system of claim 1, wherein the base unit further comprises a circulation pump configured to intake water from the water reservoir and pump the water back into the water reservoir.

4. The system of claim 1, wherein the grow tray comprises a container having an upper facing opening, a bottom panel, and at least one side wall extending between the top and bottom panels, the bottom panel including at least one egress aperture fluidly associated with the water reservoir.

5. The system of claim 1, wherein the base unit further comprises a water level monitor.

6. The system of claim 5, wherein the water level monitor comprises at least one sensor element and at least one indicator element.

7. The system of claim 6, wherein the at least one sensor is a float sensor.

8. The system of claim 1, wherein the first greenhouse module comprises an access aperture configured to allow access to at least one of the first interior volume and the base unit, and a removable cover configured to sealingly cover the access aperture.

9. The system of claim 8, wherein the cover is magnetically associated with the access aperture.

10. The system of claim 1, wherein the first greenhouse module further includes an air intake aperture obstructed by a filter element.

11. The system of claim 1, wherein the second greenhouse module comprises an access aperture configured to allow access to at least one of the second interior volume and the first interior volume, and a removable cover configured to sealingly cover the access aperture.

12. A stackable hydroponic greenhouse system, comprising:
a base unit including a water reservoir sized and configured to receive a volume of water therein, and a grow tray sized and configured to receive a volume of plant root media therein;
a first greenhouse module having four lateral walls, an open top end, an open bottom end, and a first interior volume defined by the space between the four lateral walls and top and bottom ends, the first greenhouse module further comprising an air intake aperture and first filter element obstructing the air intake element, the first greenhouse module configured to stack on top of the base unit;
a second greenhouse module having four lateral walls, a top end, an open bottom end, and a second interior volume defined by the space between the four lateral walls and top and bottom ends; and
a control unit configured to stack on top of the second greenhouse module, the control unit including a control panel, a power module, a lighting component, an air outlet aperture, an exhaust fan positioned proximate the air outlet aperture, and a second filter element obstructing the air outlet aperture;
wherein the exhaust fan is operable to create a vacuum environment within the first and second interior volumes to create a first airflow pattern wherein air is pulled into the first interior volume through the air intake aperture and first filter element and passes diagonally upward through the second interior volume and control unit before exiting the greenhouse system through the second filter element, exhaust fan, and outlet aperture.

13. The system of claim 12, wherein at least one of the base unit and the first greenhouse module has a pyramidal frustum shape.

14. The system of claim 12, wherein the first filter element comprises a particle intake filter.

15. The system of claim 12, wherein the second filter element comprises an activated carbon exhaust filter.

16. The system of claim 12, wherein the control unit further includes at least one circulating fan positioned on a bottom side of the control unit, the at least one circulating fan angularly directed into the second interior volume to create a second airflow pattern passing diagonally downward through the second interior volume and into the first interior volume.

17. A method of assembling a stackable hydroponic greenhouse system in a compact orientation for efficient storage or shipping, comprising:
a) providing a stackable hydroponic greenhouse system including:
a base unit including a water reservoir sized and configured to receive a volume of water therein, and a grow tray sized and configured to receive a volume of plant root media therein, the base unit comprising a housing element having a pyramidal frustum shape;
a first greenhouse module having four lateral walls, an open top end, an open bottom end, and a first interior volume defined by the space between the four lateral walls and top and bottom ends, the first greenhouse module having an inverted pyramidal frustum shape, the first greenhouse module configured to stack on top of the base unit;
a second greenhouse module having four lateral walls, a top end, an open bottom end, and a second interior volume defined by the space between the four lateral walls and top and bottom ends, the second greenhouse module configured to stack on top of the first greenhouse module; and
a control unit configured to stack on top of the second greenhouse module, the control unit including a control panel, a power module, and a lighting component;
b) inverting the first greenhouse module;
c) placing the inverted first greenhouse module over the control unit such that a substantial portion of the control unit is received within the first interior volume;
d) placing the second greenhouse module over the inverted first greenhouse module such that at least a portion of the first greenhouse module is received within the second interior volume, and
e) placing the control unit on top of the second greenhouse module to complete the assembly of the stackable hydroponic greenhouse system into a compact orientation.

18. The method of claim 17, comprising the further step of f) packing the compact assembly into at least one of a storage container and a shipping container.

19. The method of claim 17, comprising the further step of g) shipping the compact assembly.
